(19) United States
(12) Patent Application Publication
(10) Pub. No.: US 2017/0338653 A1
(43) Pub. Date: Nov. 23, 2017

(54) DEMAND CONTROL APPARATUS, GROUP GENERATION APPARATUS, AND GROUP GENERATION METHOD

(71) Applicant: NEC Corporation, Tokyo (JP)

(72) Inventor: Okabe TOSHIYA, Tokyo (JP)

(21) Appl. No.: 15/531,228

(22) PCT Filed: Nov. 9, 2015
(86) PCT No.: PCT/JP2015/005578

§ 371 Date: May 26, 2017

(30) Foreign Application Priority Data
Nov. 27, 2014 (JP) 2014-240001

(51) Int. Cl. H02J 3/18; H02J 3/32; H02J 3/00

(52) U.S. Cl. CPC H02J 3/18; H02J 3/32; H02J 2003/003

(57) ABSTRACT

A group generation apparatus coupled via a communication network to a plurality of consumers coupled to a power system. The group generation apparatus includes: a group size determination unit that determines a number of consumers per group that makes a difference minimum or equal to or smaller than a threshold, between a total sum of demand power of the consumers included in a same group and a forecasted value of the total sum, and a grouping unit that divides the plurality of consumers into a plurality of consumer groups in accordance with the number of consumers determined.

CROSS-REFERENCE TO RELATED APPLICATIONS

This application is a National Stage Entry of International Application No. PCT/JP2015/005578, filed Nov. 9, 2015, which claims priority from Japanese Patent Application No. 2014-240001, filed Nov. 27, 2014. The entire contents of the above-referenced applications are expressly incorporated herein by reference.

### TECHNICAL FIELD

The disclosed subject matter relates to a power demand control system, a demand control apparatus, and a group generation apparatus, its method and recording medium.

### BACKGROUND ART

Power control technologies thus far developed for an energy community that includes a multitude of consumers coupled to a power system include a technology to control the demand power of the energy community in such a way to make the demand close to a procurement projection made up in advance. In such a case, the control may be performed by dividing the multitude of consumers into a plurality of groups.

For example, a first related art proposes grouping the multitude of consumers taking the accuracy of demand forecast into account (see, for example, PTL 1). More specifically, according to the first related art, the multitude of consumers having a distributed-power-supply-apparatus or an energy storage apparatus are divided into groups of a scale according to the accuracy of the demand forecast. For example, the consumers covered with the same voltage transformer form one group, and in a case of a condominium, the entirety thereof or the households on each floor may be grouped into one consumer group. In addition, a distributed controller is provided for each of the consumer groups. The distributed controller generates an optimum procurement projection (management scheme) of the distributed-power-supply-apparatus or the energy storage apparatus of the corresponding consumer group. Further, a central control unit is provided in common for the plurality of consumer groups. The central control unit transmits, to each of the distributed controllers, control information including a control amount (time-series power rate pattern in the energy community) that allows adjustment of the power supply to each of the consumer group, to thereby complement an excess or shortage of the energy supply of the community as a whole.

### CITATION LIST

### Patent Literature

PTL 1: Japanese Patent No. 3980541 (in particular, paragraph 0019)

### SUMMARY OF INVENTION

### Technical Problem

According to the first related art, the plurality of consumers are divided into the plurality of consumer groups based on the accuracy of the demand forecast, and the distributed controllers each control the distributed-power-supply-apparatus and the energy storage apparatus according to optimum procurement projection, in such a way to bring the demand power close to the value of the procurement projection. Generally, the greater the scale of the power demand is, the higher the forecast accuracy becomes, and therefore the forecast accuracy of the procurement projection, with respect to the individual consumer group divided based on the accuracy of the demand forecast, becomes higher. However, although the forecast accuracy is the same, the difference between the value of the procurement projection and the demand power increases, the greater the scale of the power demand is. The increase of the difference between the value of the procurement projection and the demand power makes it more difficult, compared with the case where the difference is smaller, to bring the demand power close to the procurement projection. Therefore, with the method of dividing the plurality of consumers into the plurality of consumer groups based on the accuracy of the demand forecast, it is difficult to control the demand power of the consumer groups in such a way to bring the demand power close to the procurement projection of the consumer groups.

Accordingly, the disclosed subject matter provides a power demand control system capable of controlling the demand power of the consumer groups in such a way to bring the demand power close to the procurement projection of the consumer groups.

### Solution to Problem

A power demand control system according to an example embodiment of the disclosed subject matter includes: a plurality of consumers coupled to a power system and a demand control apparatus coupled to the plurality of consumers via a communication network, wherein the plurality of consumers are divided into a plurality of consumer groups, such that a difference between a total sum of demand power of the consumers included in a same group and a forecasted value of the total sum becomes minimum or equal to or smaller than a threshold, and the demand control apparatus adjusts, with respect to each of the consumer groups, demand power of the consumer group in such a way to bring the demand power of consumer group close to a procurement projection of the consumer group.

A demand control apparatus coupled via a communication network to a plurality of consumers coupled to a power system, according to another example embodiment of the disclosed subject matter, the demand control apparatus includes: a group size determination unit that determines a number of consumers per group that makes a difference minimum or equal to or smaller than a threshold, between a total sum of demand power of the consumers included in a same group and a forecasted value of the total sum; a grouping unit that divides the plurality of consumers into a plurality of consumer groups in accordance with the number of consumers determined; and a power management unit that adjusts, with respect to each of the consumer groups, the demand power of the consumer group in such a way to bring the demand power of the consumer group close to the procurement projection of the consumer group.

A group generation apparatus coupled via a communication network to a plurality of consumers coupled to a power system, according to another example embodiment of the disclosed subject matter, the group generation apparatus includes: a group size determination unit that determines a number of consumers per group that makes a difference minimum or equal to or smaller than a threshold, between a total sum of demand power of the consumers included in a same group and a forecasted value of the total sum; and grouping unit that divides the plurality of consumers into a plurality of consumer groups in accordance with the number of consumers determined.

A group generation method to be executed by a group generation apparatus coupled via a communication network to a plurality of consumers coupled to a power system, according to another example embodiment of the disclosed subject matter, the group generation method includes: determining a number of consumers per group that makes a difference minimum or equal to or smaller than a threshold, between a total sum of demand power of the consumers included in a same group and a forecasted value of the total sum; and dividing the plurality of consumers into a plurality of consumer groups in accordance with the number of consumers determined.

A program configured to cause a computer, coupled via a communication network to a plurality of consumers coupled to a power system, according to another example embodiment of the disclosed subject matter, to function as: a group size determination unit that determines a number of consumers per group that makes a difference minimum or equal to or smaller than a threshold, between a total sum of demand power of the consumers included in a same group and a forecasted value of the total sum; and a grouping unit that divides the plurality of consumers into a plurality of consumer groups in accordance with the number of consumers determined.

### Advantageous Effects of Invention

The foregoing arrangements facilitate the demand power of the consumer groups to be brought closer to the procurement projection of the consumer groups.

### BRIEF DESCRIPTION OF DRAWINGS

FIG. 1 is a block diagram of a power demand control system according to a first example embodiment;

FIG. 2 is a block diagram of a consumer in the power demand control system according to the first example embodiment;

FIG. 3 is a block diagram of a demand control apparatus in the power demand control system according to the first example embodiment;

FIG. 4 is a table illustrating an example of consumer data in the power demand control system according to the first example embodiment;

FIG. 5 is a graph illustrating an example of first relation data in the power demand control system according to the first example embodiment;

FIG. 6 is a graph illustrating an example of second relation data in the power demand control system according to the first example embodiment;

FIG. 7 is a graph illustrating an example of third relation data in the power demand control system according to the first example embodiment;

FIG. 8 is a graph illustrating an example of fourth relation data in the power demand control system according to the first example embodiment;

FIG. 9 is a table illustrating an example of group information in the power demand control system according to the first example embodiment;

FIG. 10 is a flowchart illustrating an operation of the demand control apparatus in the power demand control system according to the first example embodiment;

FIG. 11 is a block diagram of a demand control apparatus according to a second example embodiment;

FIG. 12 is a flowchart illustrating an operation of the demand control apparatus according to the second example embodiment:

FIG. 13 is a block diagram of a power demand control system according to a third example embodiment;

FIG. 14 is a block diagram of a demand control apparatus in the power demand control system according to the third example embodiment;

FIG. 15 is a table illustrating an example of energy storage apparatus data in the power demand control system according to the third example embodiment;

FIG. 16 is a table illustrating an example of distributed-power-supply-apparatus data in the power demand control system according to the third example embodiment;

FIG. 17 is a table illustrating an example of group information is the power demand control system according to the third example embodiment;

FIG. 18 is a flowchart illustrating an operation of the demand control apparatus according to the third example embodiment:

FIG. 19 is a block diagram of a power demand control system according to a fourth example embodiment;

FIG. 20 is a flowchart illustrating an operation of the demand control apparatus according to the fourth example embodiment;

FIG. 21 is a block diagram of a group generation apparatus according to a fifth example embodiment;

FIG. 22 is a flowchart illustrating an operation of the group generation apparatus according to the fifth example embodiment; and

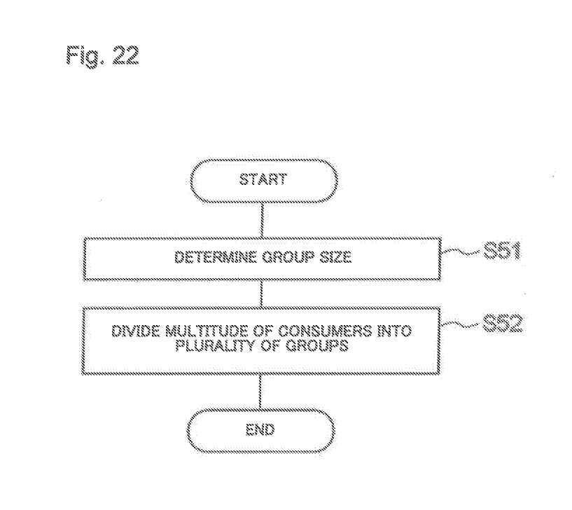

FIG. 23 is a graph illustrating an example of fourth relation data for explaining another example embodiment.

### DESCRIPTION OF EMBODIMENTS

Example embodiments of the disclosed subject matter will be described in detail with reference to the drawings.

### First Example Embodiment

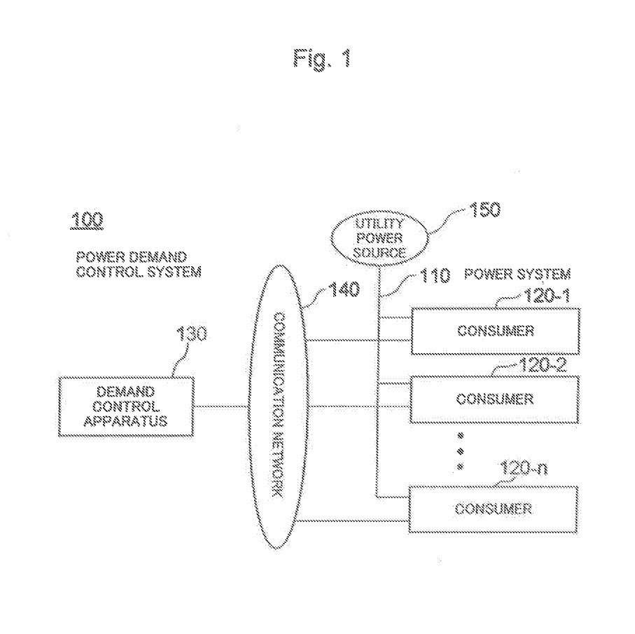

Referring to FIG. 1, a power demand control system 100 according to a first example embodiment controls power demand from an energy community that includes a plurality of consumers 120 coupled to a power system 110.

The power demand control system 100 includes the plurality of consumers 120 coupled to the power system 110 and a demand control apparatus 130. The demand control apparatus 130 is coupled to each of the consumers 120 via a communication network 140.

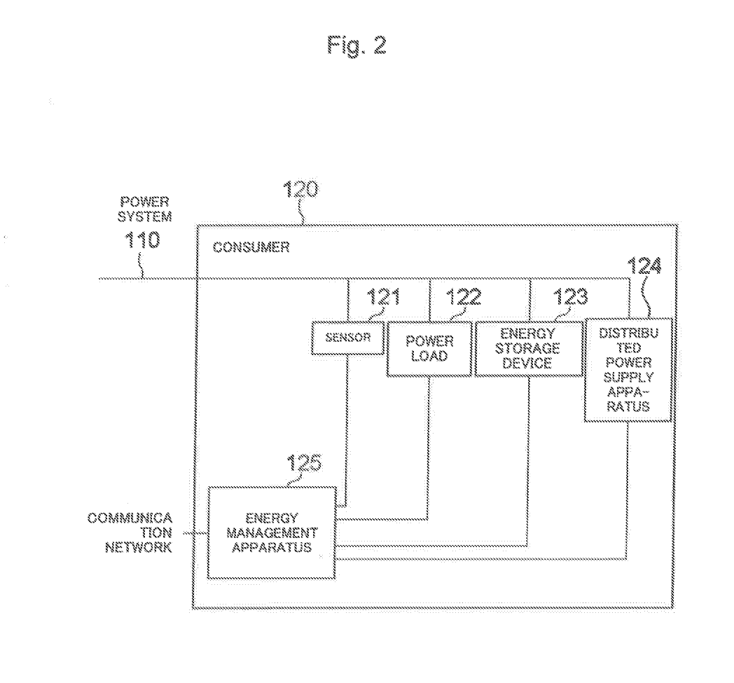

The consumers 120 include, for example, households in detached houses or individual households in apartments or condominiums. FIG. 2 is a block diagram illustrating an example of a configuration of the consumer 120. The consumer 120 illustrated in FIG. 2 includes a sensor 121, a power load 122, and an energy storage apparatus 123 coupled to the power system 110, a distributed-power-supply-apparatus 124, and an energy management apparatus 125 coupled to the mentioned components, with wire or wirelessly.

The sensor 121 measures the amount of power demand from the consumer 120. The power load 122 includes electric appliances (e.g., home appliances such as a refrigerator) that consume electricity.

The energy storage apparatus 123 is a storage cell such as a lithium ion battery. The energy storage apparatus 123 can be charged with the power supplied from the power system 110, and also supply the stored power to the power system 110. Accordingly, the power demand of the consumer 120 can be adjusted through the charging and discharging of the energy storage apparatus 123.

The distributed-power-supply-apparatus 124 may be, for example, a solar cell, a fuel cell, or a diesel engine generator. The distributed-power-supply-apparatus 124 cars supply the generated power to the power system 110. The power demand of the consumer 120 can be adjusted with the power supply from the distributed-power-supply-apparatus 124.

The energy management apparatus 125 may be, for example, a home energy management system (HEMS), which performs energy management for the consumer 120. The energy management apparatus 125 retains the power demand amount of the consumer 120 measured by the sensor 121 for a predetermined period in the past, and transmits such data to the demand control apparatus 130 through the communication network 140. The energy management apparatus 125 also acquires data indicating the status of the power load 122 (e.g., whether on or off, and operation mode), data indicating the status of the energy storage apparatus 123 (e.g., maximum charge capacity, current charge amount, and operation mode whether charging, discharging, or off), and data indicating the status of the distributed-power-supply-apparatus 124 (e.g., maximum generation capacity, current generation amount, and operation mode whether on or off), from the power load 122, the energy storage apparatus 123, and the distributed-power-supply-apparatus 124, and retains such data, and transmit the data to the demand control apparatus 130 through the communication network 140. The energy management apparatus 125 also receives various instructions from the demand control apparatus 130 through the communication network 140, and controls the operation of the power load 122, the energy storage apparatus 123, and the distributed-power-supply-apparatus 124, according to the instruction received.

Although the consumer 120 illustrated in FIG. 2 includes the energy storage apparatus 123 and the distributed-power-supply-apparatus 124, some of the plurality of consumers 120 may be without either or any of the energy storage apparatus 123 and the distributed-power-supply-apparatus 124.

The demand control apparatus 130 serves to control the power demand of the energy community included the plurality of consumers 120. The demand control apparatus 130 divides the plurality of consumers 120 constituting the energy community into a plurality of groups, and adjusts, with respect to each of the groups, the demand power of the group in such a way to bring the demand power close to the procurement projection of the group. With such an arrangement, the overall power demand of the energy community can be brought close to the procurement projection of the energy community.

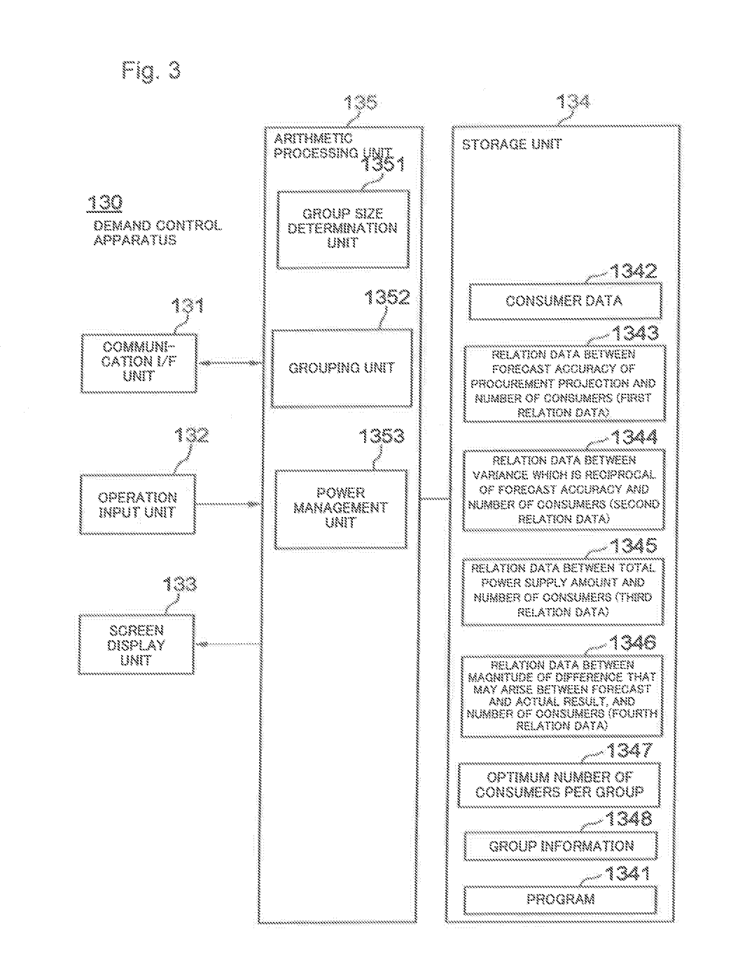

FIG. 3 is a block diagram illustrating an example of a configuration of the demand control apparatus 130. The demand control apparatus 130 illustrated in FIG. 3 includes, as essential functional components, a communication interface unit (hereinafter, communication I/F unit) 131, an operation input unit 132, a screen display unit 133, a storage unit 134, and an arithmetic processing unit 135.

The communication I/F unit 131 includes an exclusive data communication circuit, and is configured to perform data communication with the components of the consumer 120, for example the energy management apparatus 125, coupled via the communication network 140.

The operation input unit 132 includes operation input devices such as a keyboard and a mouse, and is configured to detect an operation made by an operator, and output the detected operation to the arithmetic processing unit 135.

The screen display unit 133 is constituted of a display device such as a liquid crystal display (LCD) or a plasma display panel (PDF), and configured to display various kinds of information, for example an operation menu, on a screen, according to an instruction from the arithmetic processing unit 135.

The storage unit 134 includes a storage device such as a hard disk or a memory, and serves to store therein processing information required for various processing performed by the arithmetic processing unit 135 and a program 1341. The program 1341 is utilized to realize the functional components by being read into the arithmetic processing unit 135 and executed. The program 1341 is read in advance from a non-illustrated external device or a storage medium by means of a data input/output function, for example the communication I/F unit 131, and stored in the storage unit 134. Essential processing information stored in the storage unit 134 includes consumer data 1342, relation data 1343 between the forecast accuracy of the procurement projection and the number of consumers, relation data 1344 between variance which is the reciprocal of the forecast accuracy and the number of consumers, relation data 1345 between total power supply amount and the number of consumers, relation data 1346 between magnitude of difference that may arise between forecast and actual result, and the number of consumers, the optimum number 1347 of consumers per group, and group information 1348.

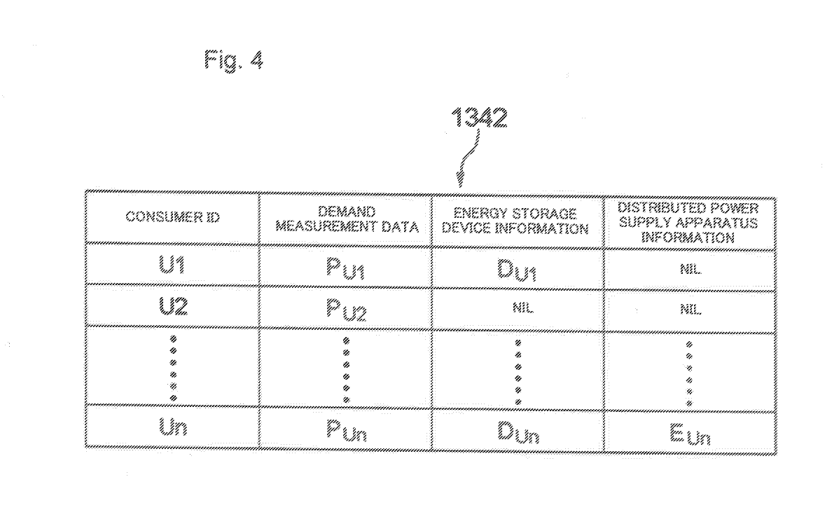

The consumer data 1342 is related to each of the consumers 120. FIG. 4 represents an example of the consumer data 1342. The consumer data 1342 illustrated in FIG. 4 includes entries containing a set of a consumer ID, demand measurement data, energy storage apparatus information, and distributed-power-supply-apparatus information, with respect to each of the consumers 120. For example, the entry of the uppermost column indicates that past measurement data of a consumer having a consumer ID of U1 is PU1, that the consumer possesses an energy storage apparatus, the maximum charge capacity of the energy storage apparatus is DU1, and that the distributed-power-supply-apparatus information is unavailable. The demand measurement data may be time-series data of the demand during a predetermined period (e.g., a day), or data of average demand or peak demand during the predetermined period. In the column of the energy storage apparatus information, the maximum charge capacity is entered when the customer possesses an energy storage apparatus, but NIL is marked when the customer is without the energy storage apparatus. In the column of the distributed-power-supply-apparatus information, the maximum generation capacity is entered when the customer possesses a distributed-power-supply-apparatus and NIL is marked when the customer is without the distributed-power-supply-apparatus. Here, the data indicating whether the customer possesses the energy storage apparatus or the distributed-power-supply-apparatus. Other data such as the maximum charge capacity or the maximum generation capacity may be indicated in combination.

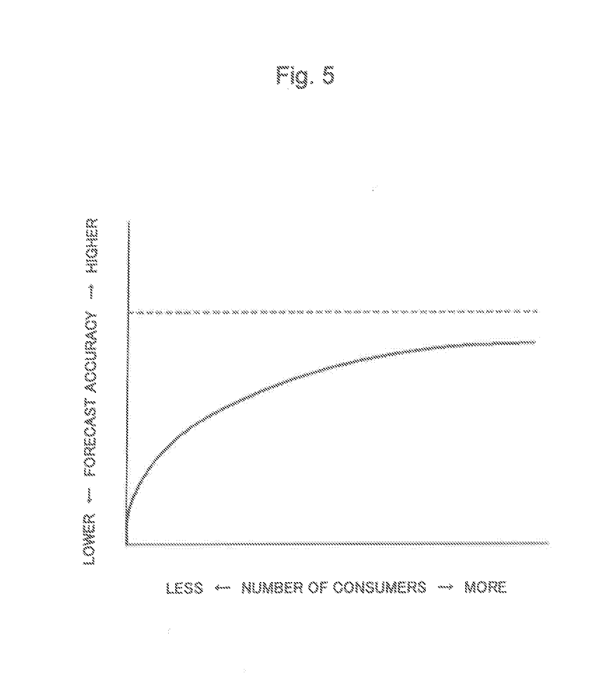

The relation data 1343 between the forecast accuracy of the procurement projection and the number of consumers (hereinafter, first relation data) represents the relationship between the scale of the consumer group and the accuracy of the demand forecast with respect to the corresponding consumer group. FIG. 5 represents an example of the first relation data 1343. The first relation data 1343 illustrated in FIG. 5 indicates that the accuracy of the demand forecast with respect to the consumer group becomes higher, the larger the number of consumers is, in other words the larger the scale of the consumer group is. Although FIG. 5 represents the first relation data 1343 in the form of a graph, the first relation data 1343 may be expressed by an equation.

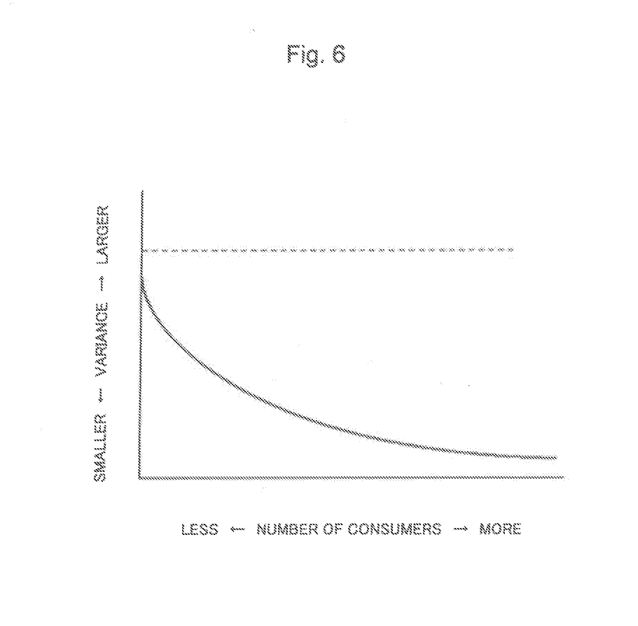

The relation data 1344 between the variance, which is the reciprocal of the forecast accuracy, and the number of consumers (hereinafter, second relation data) represents the relationship between the scale of the consumer group and the variance which is the reciprocal of the accuracy of the demand forecast with respect to the corresponding consumer group. FIG. 6 represents an example of the second relation data 1344. The second relation data 1344 illustrated in FIG. 6 indicates that the accuracy of the variance which is the reciprocal of the accuracy of the demand forecast with respect to the consumer group becomes smaller, the larger the number of consumers is, in other words the larger the scale of the consumer group is. Although FIG. 6 represents the second relation data 1344 in the form, of a graph, the second relation data 1344 may be expressed by an equation.

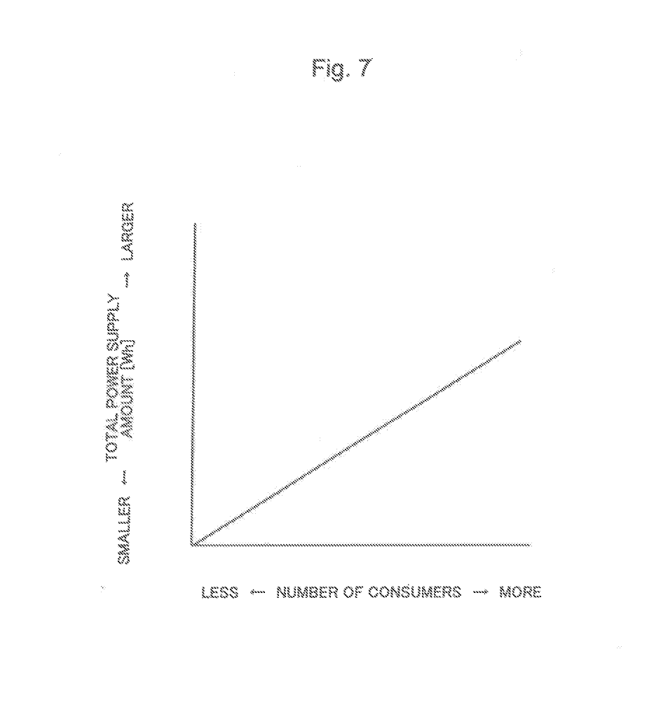

The relation data 1345 between the total power supply amount and the number of consumers (hereinafter, third relation data) represents the relationship between the scale of the consumer group and the total amount of the demand power of the corresponding consumer group. FIG. 7 represents an example of the third relation data 1345. The third relation data 1345 illustrated in FIG. 7 indicates that the number of consumers, in other words the scale of the consumer group and the total amount of the demand power of the consumer group are generally proportionate to each other.

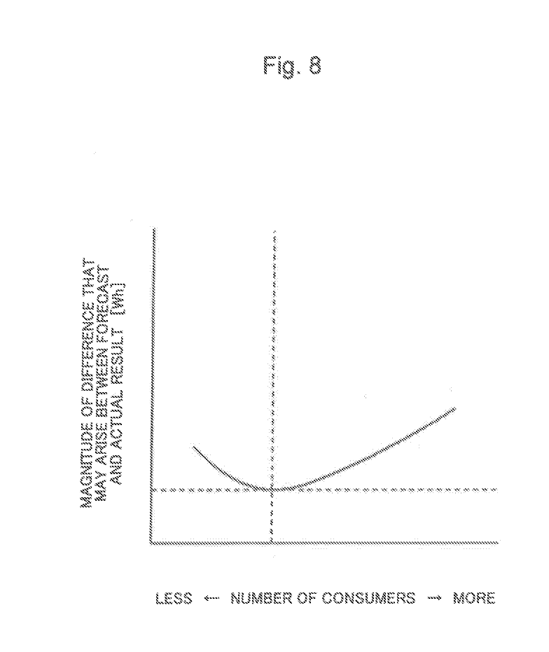

The relation data 1346 between the magnitude of difference that may arise between forecast and an actual result, and the number of consumers (hereinafter, fourth relation data) represents the relationship between the scale of the consumer group and the difference between the total sum of the demand power of the corresponding consumer group and the forecasted value of the total sum. FIG. 8 represents an example of the fourth relation data 1346. The fourth relation data 1346 illustrated in FIG. 8 indicates that the difference between the forecast and the actual result becomes minimum when the scale of the consumer is of a certain level, or a certain number of consumers, and that the difference increases with an Increase or decrease of the number of consumers.

The optimum number 1347 of consumers per group is a parameter utilized when the plurality of consumers 120 are divided into a plurality of groups.

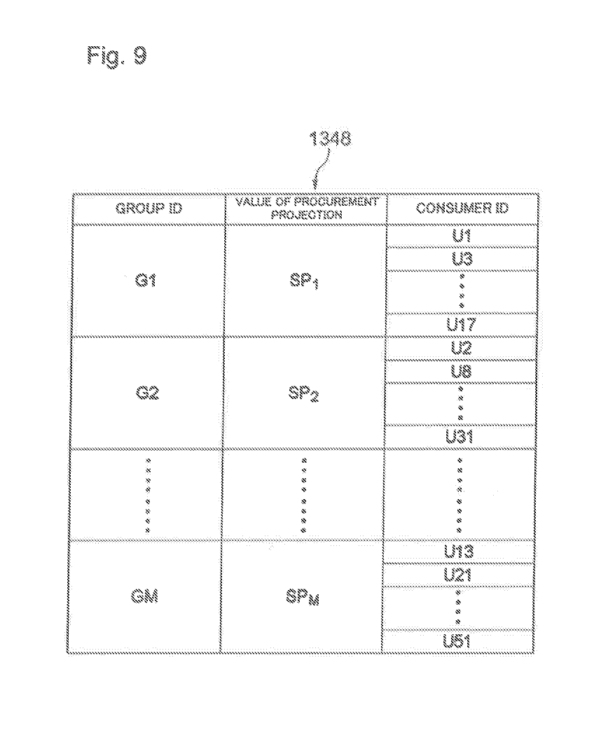

The group information 1348 is related to the plurality of consumer groups. FIG. 9 represents an example of the group information 1348. The group information 1348 illustrated in FIG. 9 includes entries a set of a group ID, the power procurement projection for the corresponding consumer group, and a list of consumers included in the consumer group (list of consumer IDs), with respect to each of the consumer groups. For example, the entry of the uppermost column indicates that the procurement projection for a consumer group having a consumer group ID of G1 is SF1, and that the consumer group includes consumers respectively having a consumer ID of U1, U3, . . . U17.

The arithmetic processing unit 135 includes a microprocessor such as an MPU and peripheral circuits, and is configured to read the program 1341 from the storage unit 134 and execute the same, to thereby cause the hardware and the program 1341 to collaborate in such a way to realize various functional units. Examples of the functional units realized by the arithmetic processing unit 135 include a group size determination unit 1351, a grouping unit 1352, and a power management unit 1353.

The group size determination unit 1351 makes communication with the energy management apparatus 125 of the consumer 120 through the communication network 140 by means of the communication I/F unit 131, to thereby acquire the information of the consumer 120 and store the information as consumer data 1342 in the storage unit 134. The group size determination unit 1351 is also configured to read the consumer data 1342 from the storage unit 134, generate the first relation data 1343 and the third relation data 1345 based on the demand measurement data in the consumer data 1342, and store the first relation data 1343 and the third relation data 1345 in the storage unit 134. Further, the group size determination unit 1351 is configured to read the first relation data 1343 from the storage unit 134, generate the second relation data 1344 based on the first relation data 1343, and store the second relation data 1344 in the storage unit 134. In addition, the group size determination unit 1351 is configured to read the second relation data 1344 and the third relation data 1345 from the storage unit 134, generate the fourth relation data 1346 based on the second relation data 1344 and the third relation data 1345, and store the fourth relation data 1346 in the storage unit 134. Still further, the group size determination unit 1351 is configured to read the fourth relation data 1346 from the storage unit 134, analyze the fourth relation data 1346 to determine the number of consumers per group that makes the difference minimum, between the total sum of the demand power of the consumers 120 included in the group and the forecasted value of the total sum, and store such number of consumers as optimum number 1347 of consumers per group in the storage unit 134.

The grouping unit 1352 is configured to read the consumer data 1342 and the optimum number 1347 of consumers per group from the storage unit 134. The grouping unit 1352 is configured to divide all the consumers 120 listed up in the consumer data 1342 into a plurality of groups including the same number of consumers 120 as the optimum number 1347. The grouping unit 1352 is configured to generate the group information 1348 through the dividing of the consumers, and store the group information 1348 in the storage unit 134. The procurement projection for each group in the group information 1348 may be made up by a desired method, for example making a forecast based on past demand measurement data of the consumers 120 included in the same group. Alternatively, the grouping unit 1352 may adopt any of the following group dividing methods. It is to be noted, however, that the disclosed subject matter is not limited to the methods described hereunder.

### <First Example of Group Dividing Method>

The same number of consumers 120 as the optimum number 1347 may be selected out of the consumers 120 listed up in the consumer data 1342 to form a group, in such a way to satisfy the condition that each group includes at least one consumer having the energy storage apparatus 123. In a case where a fewer number of consumers 120 than the optimum number 1347 are left finally, another consumer group may be formed of those consumers, or equally allocate those consumers to each of the consumer groups already formed.

### <Second Example of Group Dividing Method>

The same number of consumers 120 as the optimum number 1347 may be selected out of the consumers 120 listed up in the consumer data 1342 to form a group, in such a way to satisfy the condition that each group includes at least one consumer having the energy storage apparatus 123, and the total of the maximum charge capacity of the energy storage apparatuses 123 in the same group is equal to or larger than a reference value. Here, the grouping unit 1352 may read the fourth relation data 1346 from the storage unit 134, analyze the fourth relation data 1346 in such a way to obtain a minimum value (expected value) of the difference between the total sum of the demand power of the consumers 120 in the same group and the forecasted value of the total sum, and set such a minimum value as the reference value. Although in this example the grouping unit 1352 calculates the minimum value of the difference, the group size determination unit 1351 may calculate the minimum value and store it in the storage unit 134. In addition, the grouping unit 1352 may look up the energy storage apparatus information in the consumer data 1342, to thereby confirm whether the consumer has the energy storage apparatus, as well as the maximum charge capacity thereof when the consumer has one.

### <Third Example of Group Dividing Method>

The same number of consumers 120 as the optimum number 1347 may be selected out of the consumers 120 listed up in the consumer data 1342 to form a group, in such a way to satisfy the condition that each group includes at least one consumer having the distributed-power-supply-apparatus 124.

### <Fourth Example of Group Dividing Method>

The same number of consumers 120 as the optimum number 1347 may be selected out of the consumers 120 listed up in the consumer data 1342 to form a group, in such a way to satisfy the condition that each group includes at least one consumer having the distributed-power-supply-apparatus 124, and the total of the maximum generation capacity of the distributed-power-supply-apparatus 124 in the same group is equal to or larger than a reference value. The reference value may be determined in the same manner as in the second example of the group dividing method. In addition, the grouping unit 1352 may look up the distributed-power-supply-apparatus information in the consumer data 1342, to thereby confirm whether the consumer has the distributed-power-supply-apparatus, as well as the maximum generation capacity thereof when the consumer has one.

### <Fifth Example of Group Dividing Method>

The same number of consumers 120 as the optimum number 1347 may be randomly selected out of the consumers 120 listed up in the consumer data 1342 to form a group, using random numbers.

### <Sixth Example of Group Dividing Method>

The same number of consumers 120 as the optimum number 1347 may be selected out of the consumers 120 listed up in the consumer data 1342 to form a group, such that the consumers having a similar load profile are not included in the same group, wherever possible. For example, a demand pattern may be adopted as the load profile. Examples of the demand pattern include a case where the demand is higher in the daytime but lower at night, a case where, conversely, the demand is higher at night bat lower in the daytime, and a case where the demand is generally constant whole day. The demand pattern can be confirmed through analysis of the demand measurement data in the consumer data.

The power management unit 1353 is configured to read the group information 1348 from the storage unit 134, and adjust the demand power of the consumer group in such a way to bring the demand power close to the procurement projection of the consumer group, with respect to each of the consumer groups registered in the group information 1348. For example, the power management unit 1353 makes communication with the energy management apparatus 125 of the consumer 120 through the communication network 140 by means of the communication I/F unit 131, to thereby acquire the power demand amount measured by the sensor 121 of each consumer 120, and calculates the power demand amount of each consumer group by aggregating the respective power demand amounts of the consumers 120 in the same group. Then the power management unit 1353 compares between the procurement projection of the group registered in the procurement projection and the power demand of the group measured as above, with respect to each of the consumer groups. In a case where the actual power demand of any of the consumer groups has exceeded, or is likely to exceed, the procurement projection, the power management unit 1353 reduces the demand power of the corresponding consumer group. In contrast, in the case where the actual power demand of any of the consumer groups has not reached, or is likely to fail to reach, the procurement projection, the power management unit 1353 increases the demand power of the corresponding consumer group. Here, the power management unit 1353 may adopt any of the following reducing methods or increasing methods of the demand power. It is to be noted, however, that the disclosed subject matter is not limited to the methods described hereunder.

### <First Example of Demand Power Reducing Method>

The power management unit 1353 may cause the energy storage apparatus 123 of the consumers 120 in the consumer group to discharge. The power management unit 1353 decides whether the consumer 120 has the energy storage apparatus 123 by looking up the energy storage apparatus information in the consumer data 1342 stored in the storage unit 134. The power management unit 1353 also checks whether the energy storage apparatus 123 is not discharging and has a sufficient remaining charge, by making an inquiry to the energy management apparatus 125 of the consumer 120 through the communication network 140 by means of the communication I/F unit 131, to thereby decide which of the energy storage apparatuses 123 is to be caused to discharge. Then the power management unit 1353 transmits an instruction to cause the energy storage apparatus 123 to discharge, to the energy management apparatus 125 of the consumer 120 through the communication network 140 by means of the communication I/F unit 131. Accordingly, the power charged in the energy storage apparatus 123 is supplied to the power system 110, under the control of the energy management apparatus 125. As result, the demand power of the relevant consumer 120 is reduced. When a plurality of energy storage apparatuses 123 are included In the consumer group, all or a part of the energy storage apparatuses 123 that are prepared to discharge may be caused to discharge.

### <Second Example of Demand Power Reducing Method>

The power management unit 1353 may cause the distributed-power-supply-apparatus 124 of the consumer 120 included in the consumer group to generate power. The power management unit 1353 looks up the distributed-power-supply-apparatus information in the consumer data 1342 stored in the storage unit 134, to thereby decide whether the consumer 120 possesses the distributed-power-supply-apparatus 124. The power management unit 1353 also checks whether the distributed-power-supply-apparatus 124 is generating power, by making an inquiry to the energy management apparatus 125 of the consumer 120 through the communication network 140 by means of the communication I/F unit 131, to thereby decide which of the distributed-power-supply-apparatuses 124 is to be caused to generate power. Then the power management unit 1353 transmits an instruction to cause the distributed-power-supply-apparatus 124 to start to generate power, to the energy management apparatus 125 of the consumer 120 through the communication network 140 by means of the communication I/F unit 131. Accordingly, the

distributed-power-supply-apparatus 124 starts to generate power and the power thus generated is supplied to the power system 110, under the control of the energy management apparatus 125. As result, the demand power of the relevant consumer 120 is reduced. When a plurality of distributed-power-supply-apparatus 124 are included in the consumer group, all or a part of the distributed-power-supply-apparatuses 124 that are prepared to generate power may be caused to generate power.

### <Third Example of Demand Power Reducing Method>

The power management unit 1353 may transmit an instruction to limit maximum power consumption, to the energy management apparatus 125 of the consumer 120 through the communication network 140 by means of the communication I/F unit 131. Accordingly, when the total power consumption of the consumer exceeds a predetermined upper limit or the upper limit instructed as above, the energy management apparatus 125 reduces the total power consumption, for example, by changing a target temperature of an air-conditioner, an example of the power load 122, or cutting off the power supply to a power load of low priority, by remote control or automatically. As result, the demand power of the relevant consumer 120 is reduced.

### <First Example of Demand Power Increasing Method>

The power management unit 1353 may cause the energy storage apparatus 123 of the consumer 120 included in the consumer group to be charged. The power management unit 1353 looks up the energy storage apparatus information in the consumer data 1342 stored in the storage unit 134, to thereby decide whether the consumer 120 possesses the energy storage apparatus 123. The power management unit 1353 also checks whether the energy storage apparatus 123 is not being charged and not fully charged, by making an inquiry to the energy management apparatus 125 of the consumer 120 through the communication network 140 by means of the communication I/F unit 131, to thereby decide which of the energy storage apparatuses 123 is to be charged. Then the power management unit 1353 transmits an instruction to start to charge the energy storage apparatus 123, to the energy management apparatus 125 of the consumer 120 through the communication network 140 by means of the communication I/F unit 131. Accordingly, the energy storage apparatus 123 is charged with the power from the power system 110, under the control of the energy management apparatus 125. As result, the demand power of the relevant consumer 120 is increased. When a plurality of energy storage apparatuses 123 are included in the consumer group, the charging may be performed to all or a part of the energy storage apparatuses 123 that can be charged.

### <Second Example of Demand Power Increasing Method>

The power management unit 1353 may transmit an instruction to cancel the limitation on the maximum power consumption, to the energy management apparatus 125 of the consumer 120 through the communication network 140 by means of the communication I/F unit 131. Accordingly, the energy management apparatus 125 cancels the limitation in a case where the maximum power consumption is currently limited. The energy management apparatus 125 increases the total power consumption, for example, by resetting the target temperature of the air-conditioner, an example of the power load 122, or resuming the power supply to the power load of low priority, by remote control or automatically. As result, the demand power of the relevant consumer 120 is increased.

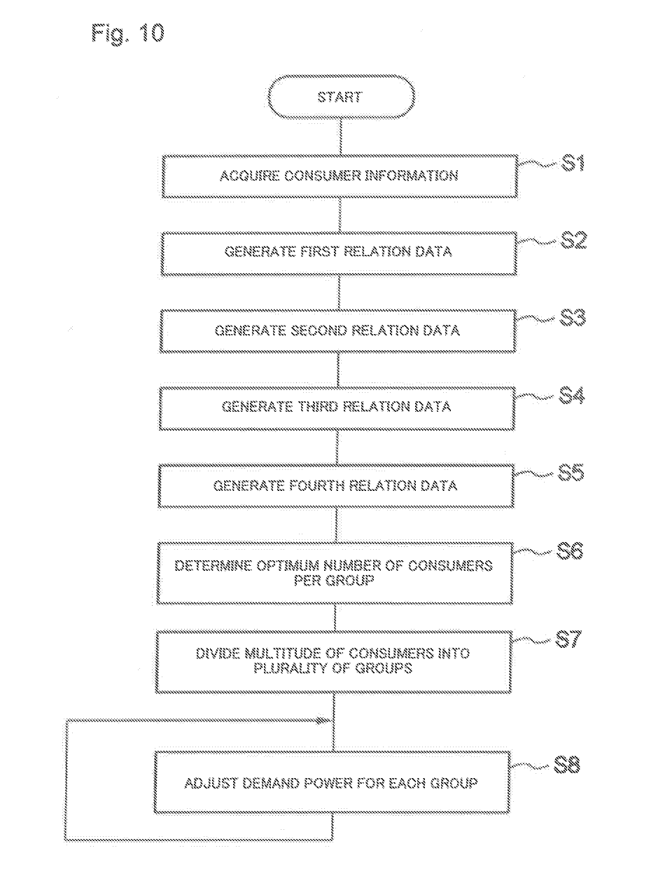

FIG. 10 is a flowchart illustrating an operation of the demand control apparatus 130. Referring to FIG. 10, the operation of the power demand control system 100 according to this example embodiment will be described hereunder.

The group size determination unit 1351 of the demand control apparatus 130 makes communication with the energy management apparatus 125 of the consumer 120 through the communication network 140 by means of the communication I/F unit 131, to acquire the information of each consumer 120 and store the information in the form of the consumer data 1342 as illustrated in FIG. 4, in the storage unit 134 (step S1).

Then the group size determination unit 1351 generates the first relation data 1343 illustrated in FIG. 5 based on the demand measurement data in the consumer data 1342, and stores the first relation data 1343 in the storage unit 134 (step S2). For the forecast accuracy, an approximate solution may be obtained from the demand measurement data on the assumption that the data has a typical statistical distribution such as exponential distribution, and the obtained result may be adopted as the forecast accuracy. Alternatively, for example, a forecasted value may be generated with respect to each of the groups the number of consumers of which is 1, 2, . . . , m (m: predetermined maximum positive integer). Then the forecasted values may be compared with the demand measurement values of the groups, the number of consumers of which is 1, 2, . . . , m}calculated by aggregating the actual demand measurement data of the plurality of consumers, and the accuracy of the forecasted values may be calculated and plotted on a graph. Then a curved line coupling the plots may be generated as the relation data.

The group size determination unit 1351 then generates the second relation data 1344 illustrated in FIG. 6 from the first relation data 1343, and stores the second relation data 1344 in the storage unit 134 (step S3). In other words, the relation between the variance, which is the reciprocal of the forecast accuracy, and the number of consumers is obtained,

The group size determination unit 1351 then generates the third relation data 1345 illustrated in FIG. 7 based on the demand measurement data in the consumer data 1342, and stores the third relation data 1345 in the storage unit 134 (step S4). For example, an approximate solution may be obtained from the demand measurement data on the assumption that the total, power supply amount is proportionate to the number of consumers, and the obtained result may be adopted as the total power supply amount. Alternatively, for example, the actual demand measurement data of the plurality of consumers may be aggregated, the total power supply amounts may be plotted on a graph, and a straight or curved line coupling the plots may be generated as the relation data to generate the total power supply amount of the demand of each of the groups wherein the number of consumers of which is 1, 2, . . . , m (m: predetermined maximum positive integer).

Thereafter, the group size determination unit 1351 generates the fourth relation data 1346 illustrated in FIG. 8 front the second relation data 1344 and the third relation data 1345, and stores the fourth relation data 1346 in the storage unit 134 (step S5). In other words, the group size determination unit 1351 obtains the relationship between the magnitude of difference that may arise between the forecast and the actual result, and the number of consumers, by multiplying the variance by the total power supply amount.

The group size determination unit 1351 then analyzes the fourth relation data 1346, to thereby determine the number of consumers per group that makes the difference minimum, between the total sum of the demand power of the consumers 120 included in the same group and the forecasted value of the total sum, and stores the determined number in the storage unit 134, as the optimum number 134 of consumers per group (step S6). At this point, the group size determination unit 1351 may determine in advance the expected value, in other words the minimum value of the difference, and store such value in the storage unit 134.

When the group size determination unit 1351 has gone through the foregoing operations, the grouping unit 1352 divides all the consumers 120 listed up in the consumer data 1342 into a plurality of groups including the same number of consumers 120 as the optimum number 1347, and generates the information 1348 of the consumer groups obtained through the dividing, and stores the group information 1348 in the storage unit 134 (step S7).

Then the power management unit 1353 adjusts, with respect to each of the consumer groups registered in the group information 1348, the demand power of the consumer group in such a way to bring the demand power close to the procurement projection of the corresponding consumer group (step S8).

As described above, the arrangement according to this example embodiment facilitates the demand power of the consumer group to be brought close to the procurement projection of the same consumer group. This is because the plurality of consumers divided into the groups such that the difference between the total sum of the demand power of the consumers included in the same group and the forecasted value of the total sum becomes minimum.

The arrangement according to this example embodiment also facilitates the demand power of the consumer group to be brought close to the procurement projection of the same consumer group, through charging or discharging of the energy storage apparatus. This is because the plurality of consumers are divided into the plurality of consumer groups in such a way to satisfy the condition that each group includes at least one consumer who has the energy storage apparatus, and that the total of the maximum charge capacity of the energy storage apparatuses in the same group is equal to or larger than the minimum value of the difference between the total sum of the demand power of the consumers Included in the relevant group and the forecasted value of the total sum.

Further, the arrangement according to this example embodiment also facilitates the demand power of the consumer group to be brought close to the procurement projection of the same consumer group, through the power generation by the distributed-power-supply-apparatus. This is because the plurality of consumers are divided into the plurality of consumer groups in such a way to satisfy the condition that each group includes at least one consumer who has the distributed-power-supply-apparatus, and that the total of the maximum generation capacity of the distributed-power-supply-apparatus in the same group is equal to or larger than the minimum value of the difference between the total sum of the demand power of the consumers included in the relevant group and the forecasted value of the total sum.

### Second Example Embodiment

Hereunder, a power demand control system according to a second example embodiment will be described. The power demand control system according to this example embodiment is different from the power demand control system of the first example embodiment in the functions of the demand control apparatus.

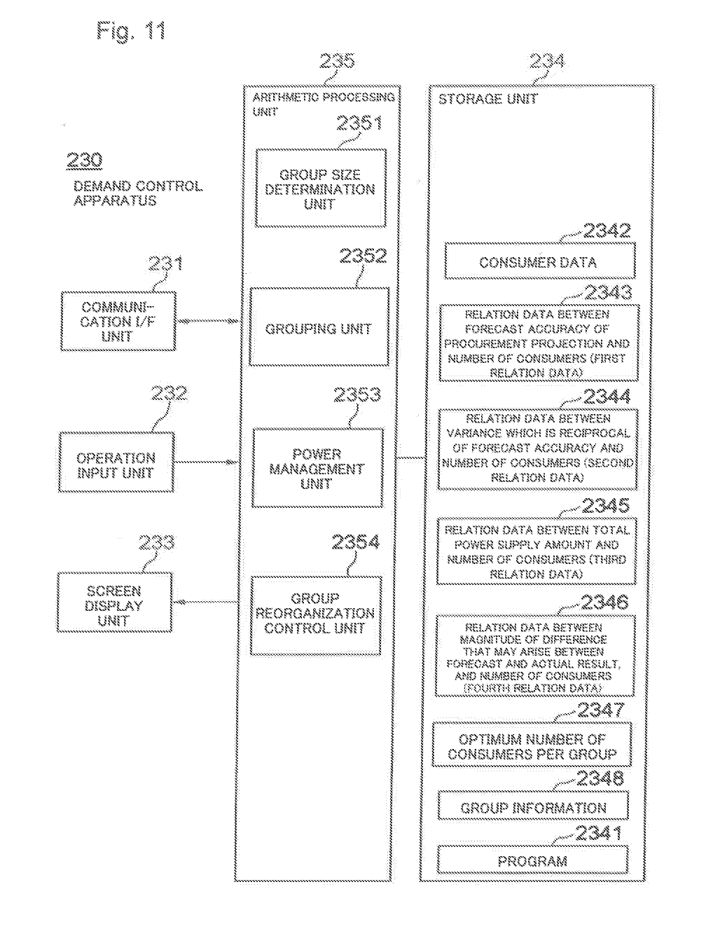

FIG. 11 is a block diagram of the demand control apparatus 230 according to this example embodiment. Referring to FIG. 11, the demand control apparatus 230 includes, as essential functional units, a communication I/F unit 231, an operation input unit 232, a screen display unit 233, a storage arm 234, and an arithmetic processing unit 235. Among the above, the communication I/F unit 231, the operation input unit 232, and the screen display unit 233 are configured to perform the same functions as the communication I/F unit 131, the operation input unit 132, and the screen display unit 133 of the demand control apparatus 130 according to the first example embodiment, respectively.

The storage unit 234 includes a storage device such as a hard disk or a memory, and serves to store therein processing information required for various processing performed by the arithmetic processing unit 235 and a program 2341. The program 2341 is utilized to realize the functional components by being read into the arithmetic processing unit 235 and executed. The program 2341 is read in advance from a non-illustrated external device or a storage medium by means of a data input/output function, for example the communication I/F unit 231, and stored in the storage unit 234. Essential processing information stored in the storage unit 234 includes consumer data 2342, relation data 2343 between the forecast accuracy of the procurement projection and the number of consumers, relation data 2344 between variance which is the reciprocal of the forecast accuracy and the number of consumers, relation data 2345 between total power supply amount and the number of consumers, relation data 2346 between magnitude of difference that may arise between forecast and actual result, and the number of consumers, the optimum number 2347 of consumers per group, and group information 2348.The cited data and information are the same as the consumer data 1342, the relation data 1343 between the forecast accuracy of the procurement projection and the number of consumers, the relation data 1344 between variance which is the reciprocal of the forecast accuracy and the number of consumers, the relation data 1345 between total power supply amount and the number of consumers, the relation data 1346 between the magnitude of difference that may arise between the forecast and the actual result, and the number of consumers, the optimum number 1347 of consumers per group, and the group information 1348, in the demand control apparatus 130 according to the first example embodiment.

The arithmetic processing unit 235 includes a microprocessor such as an MPU and peripheral circuits, and is configured to read the program 2341 from the storage unit 234 and execute the same, to thereby cause the hardware and the program 2341 to collaborate in such a way to realize various functional units. Examples of the functional units realized by the arithmetic processing unit 235 include a group size determination unit 2351, a grouping unit 2352, a power management unit 2353, and a group reorganization control unit 2354. Among the above, the group size determination unit 2351, the grouping unit 2352, and the power management unit 2353 are configured to perform the same functions as the group size determination unit 1351, the grouping unit 1352, and the power management unit 1353 of the demand control apparatus 130 according to the first example embodiment, respectively.

The group reorganization control unit 2354 is configured to control the reorganization of the consumer groups originating from an increase or decrease in number of consumers. Further details of the functions of the group reorganization control unit 2354 will be described hereunder.

The group reorganization control unit 2354 is configured to receive update information of the consumers from a remote terminal through the communication I/F unit 231 or through the operation input unit 232, and update the consumer data 2342 and the group information 2348. The consumer update information includes an update type and consumer information. The update type includes addition, deletion, and modification. The addition refers to a new entry in the energy community, the deletion refers to secession from the energy community, and the modification refers to new installation or deletion of the energy storage apparatus and the distributed-power-supply-apparatus. When the update information represents the addition, the group reorganization control unit 2354 additionally registers the consumer information received in the consumer data 2342 in the storage unit 234, adds the ID of the added consumer to the group including the fewest number of consumers in the group information 2348 in the storage unit 234, and updates the procurement projection of the group. When the update information represents the deletion, the group reorganization control unit 2354 deletes the entry of the consumer having the ID that accords with the consumer ID received, from the consumer data 2342 in the storage unit 234, deletes the received consumer ID from the group information 2348 in the storage unit 234, and updates the procurement projection of the group from which the deletion has been done. When the update information represents the modification, the group reorganization control unit 2354 updates the energy storage apparatus information and the distributed-power-supply-apparatus information corresponding to the entry of the consumer having the ID that accords with the consumer ID received, in the consumer data 2342 in the storage unit 234.

After updating the consumer data 2342 or the group information 2348 according to the consumer update information, the group reorganization control unit 2354 decides whether the group size determination unit 2351 has to redetermine the group size. For example, the group reorganization control unit 2354 may display the content of the consumer update information received and the updated consumer data 2342 or group information 2348 on the screen display unit 233, so that the operator can input the instruction regarding the necessity of the redetermination of the group size through the operation input unit 232, and follow the instruction. Alternatively, the group reorganization control unit 2354 may cheek whether an increase or decrease in number of consumers from the previous determination of the group size is equal to or larger than a predetermined threshold, and may decide that the redetermination of the group size is necessary when the increase or decrease In number of consumers is equal to or larger than the threshold, but otherwise may decide that the redetermination is unnecessary. Further, the group reorganization control unit 2354 may check whether a first condition has been satisfied that the number of consumer groups, in which the difference of the number of consumers from the optimum number 2347 of consumers per group is larger than a certain level, is equal to or more than a certain threshold, and may decide that the redetermination of the group size is necessary when the first condition is satisfied, but otherwise may decide that the redetermination is unnecessary.

Upon deciding that the redetermination of the group size is necessary, the group reorganization control unit 2354 activates the group size determination unit 2351. The group size determination unit 2351 executes, upon being activated, the process same as steps S2 to S6 illustrated in FIG. 10. As result, the first to the fourth relation data 2343 to 2346 and the optimum number 2347 of consumers per group in the storage unit 234 are updated.

The group reorganization control unit 2354 further decides whether it is necessary to reorganize the group, after the group size determination unit 2351 has completed the mentioned process when the redetermination of the group size is decided to be necessary, or immediately after deciding that the redetermination of the group size is unnecessary. For example, the group reorganization control unit 2354 may display the content of the consumer update information received, the updated consumer data 2342 or group information 2348, and the redetermined optimum number 2347 of consumers per group on the screen display unit 233, so that the operator can input the instruction regarding the necessity of the reorganization of the group through the operation input unit 232, and follow the instruction. Alternatively, the group reorganization control unit 2354 may check whether a second condition has been satisfied that the number of consumer groups, in which the difference of the number of consumers from the updated optimum number 2347 of consumers per group is larger than a certain level, is equal to or more than a certain threshold, and may decide that the reorganization of the group is necessary when the second condition is satisfied, but otherwise may decide that the reorganization is unnecessary. Further, in a case of deciding whether it is necessary to reorganize the group without going through the redetermination of the group size, the group reorganization control unit 2354 may check whether in any of the consumer groups registered in the updated group information 2348 the total of the maximum charge capacity of the energy storage apparatuses in the group has dropped below the minimum value of the difference, owing to the consumer update information related to the deletion of the energy storage apparatus, and may decide that the group reorganization is necessary when such a consumer group is found, but otherwise may decide that the reorganization is unnecessary. Alternatively, in the case of deciding whether it Is necessary to reorganize the group without going through the redetermination of the group size, the group reorganization control unit 2354 may check whether in any of the consumer groups registered in the updated group information 2348 the total of the maximum generation capacity of the distributed-power-supply-apparatuses in the group has dropped below the minimum value of the difference, owing to the consumer update information related to the deletion of the distributed-power-supply-apparatus, and may decide that the group reorganization is necessary when such a consumer group is found, but otherwise may decide that the reorganization is unnecessary.

Upon deciding that the reorganization of the group is necessary, the group reorganization control unit 2354 activates the grouping unit 2352. The grouping unit 2352 executes, upon being activated, the process same as step S7 illustrated in FIG. 10. As result, the group information 2348 in the storage unit 234 is updated. The power management unit 2353 controls the demand power of the corresponding consumer group according to the updated group information 2348, in such a way to bring the demand power close to the procurement projection of the consumer group, with respect to each of the consumer groups registered in the group information 2348.

Hereunder, the operation of the power demand control system according to this example embodiment will be described. The power demand control system according to this example embodiment operates in the same way as the power demand control system according to the first example embodiment, except for the operation of the group reorganization control unit 2354 of the demand control apparatus 230. Therefore, only the operation of the group reorganization control unit 2354 of the demand control apparatus 230 will be described hereunder.

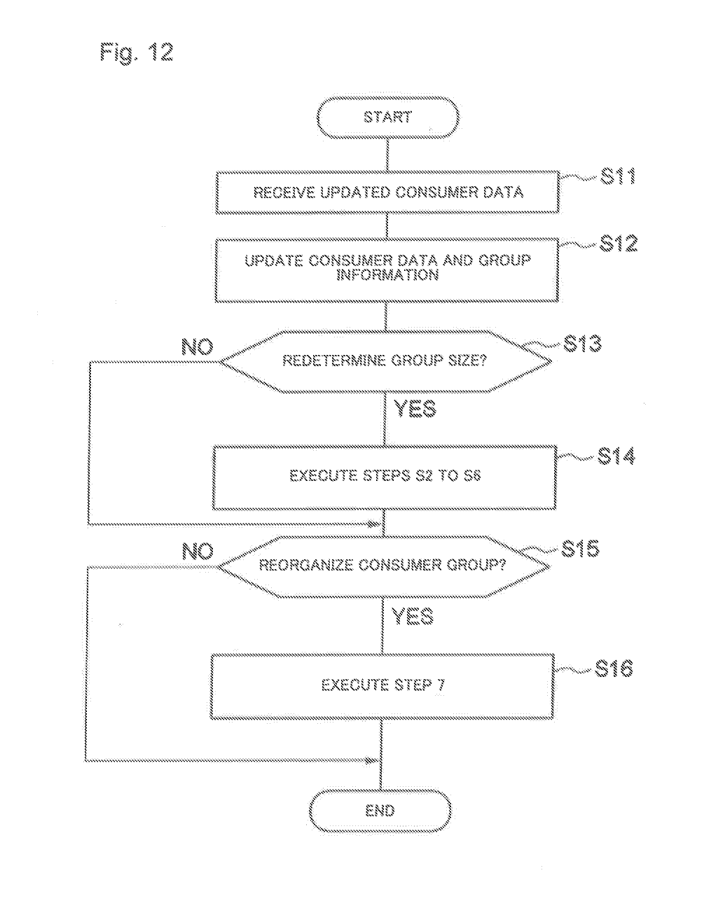

FIG. 12 is a flowchart illustrating the operation of the group reorganization control unit 2354 of the demand control apparatus 230. Referring to FIG. 12, upon receipt of the update information of the consumers from a remote terminal through the communication I/F unit 231, or through the operation input unit 232 (step S11), the group reorganization control unit 2354 updates the consumer data 2342 and the group information 2348 (step S12).

Then the group reorganization control unit 2354 decides whether determination unit 2351 has to redetermine the group size (step S13). Upon deciding that the redetermination of the group size is necessary (YES at step S13), the group reorganization control unit 2354 causes the group size determination unit 2351 to execute the same process as steps S2 to S6 illustrated in FIG. 10 (step S14), and proceeds to step S15. Upon deciding that the redetermination of the group size is unnecessary (NO at step S13), the group reorganization control unit 2354 skips the process of step S14 and proceeds to step S15.

At step S15, the group reorganization control unit 2354 decides whether the reorganization of the group is necessary. Upon deciding that the reorganization of the group is necessary (YES at step S15), the group reorganization control unit 2354 causes the grouping unit 2352 to execute the same process as step S7 illustrated in FIG. 10 (step S16). Upon deciding that the reorganization of the group is unnecessary (NO at step S15), the group reorganization control unit 2354 finishes the process illustrated in FIG. 12.

As described above, the arrangement according to this example embodiment not only provides the same advantageous effects as those of the first example embodiment, but also maintains the group size that facilitates the demand power of the consumer group to be brought close to the procurement projection of the group, even though the number of consumers is increased or decreased. This is because the redetermination of the group size and the reorganization of the group are performed if need be, when the number of consumers Is increased or decreased.

In addition, the arrangement according to this example embodiment facilitates the demand power of the consumer group to be brought close to the procurement projection of the group through charging and discharging of the energy storage apparatus, even though the energy storage apparatus is removed from a part of the consumers. This is because, in a case where in any of the consumer groups the total of the maximum charge capacity of the energy storage apparatuses in the group has dropped below the minimum value of the difference owing to the deletion of the energy storage apparatus from a part of the consumers, the plurality of consumers are reorganized into a plurality of consumer groups in such a way to satisfy the condition that each group includes at least one consumer who has the energy storage apparatus, and that the total of the maximum charge capacity of the energy storage apparatuses in the same group is equal to or larger than the minimum value of the difference.

Further, the arrangement according to this example embodiment facilitates the demand power of the consumer group to be brought close to the procurement projection of the group through power generation by the distributed-power-supply-apparatus, even though the distributed-power-supply-apparatus is removed from a part of the consumers. This is because, in the case where in any of the consumer groups the total of the maximum generation capacity of the distributed-power-supply-apparatuses in the group has dropped below the minimum value of the difference owing to the deletion of the distributed-power-supply-apparatus from a part of the consumers, the plurality of consumers are reorganized into a plurality of consumer groups in such a way to satisfy the condition that each group includes at least one consumer who has the distributed-power-supply-apparatus, and that the total of the maximum generation capacity of the distributed-power-supply-apparatuses in the same group is equal to or larger than the minimum value of the difference.

### Third Example Embodiment

Hereunder, a power demand control system according to a third example embodiment will be described.

The power demand control system according to this example embodiment is different from the power demand control system of the first example embodiment in that an energy storage apparatus and a distributed-power-supply-apparatus provided independently from the consumer are coupled to the power system.

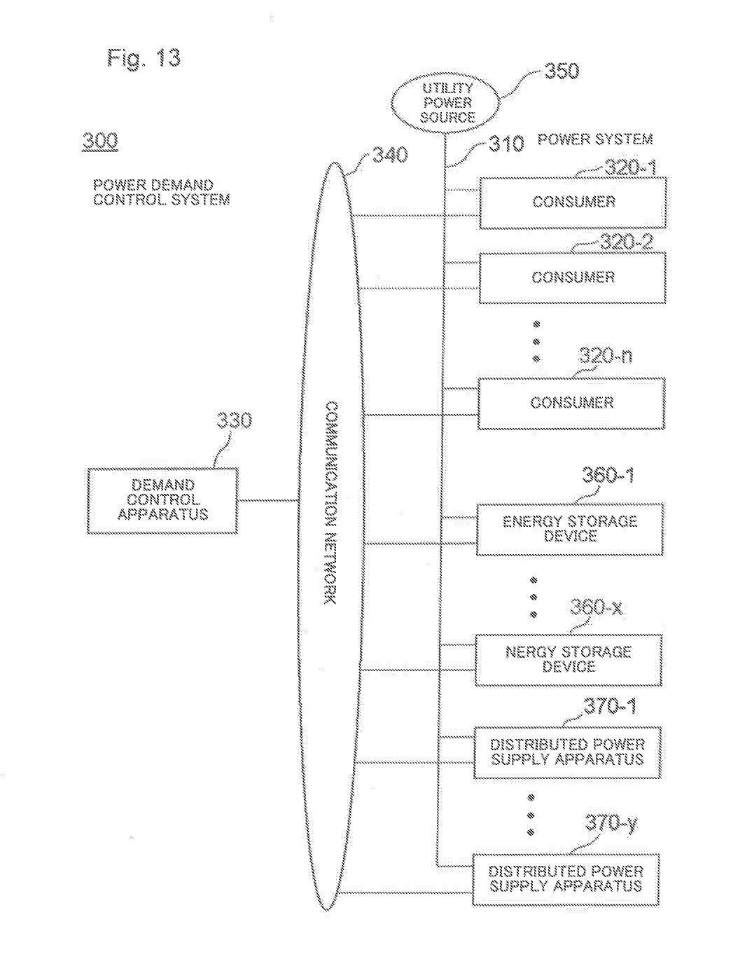

Referring to FIG. 13, the power demand control system 300 according to this example embodiment controls the power demand from an energy community that includes a plurality of consumers 320 coupled to a power system 310. The power demand control system 300 includes the plurality of consumers 320 coupled to the power system 310, an energy storage apparatus 360, a distributed-power-supply-apparatus 370, and a demand control apparatus 330. The demand control apparatus 330 is coupled to each of the consumers 320, the energy storage apparatuses 360, and the distributed-power-supply-apparatuses 370 via a communication network 340. The utility power source 350, the power system 310, and the consumers 320 are the same as the utility power source 150, the power system 110, and the consumers 120 according to the first example embodiment, respectively.

The energy storage apparatus 360 is a storage cell such as a lithium ion battery. The energy storage apparatus 360 can be charged with the power supplied from the power system 310, and also supply the stored power to the power system 310. Accordingly, the power demand of the energy community can be adjusted through the charging and discharging of the energy storage apparatus 360.

The distributed-power-supply-apparatus 370 may be, for example, a solar cell, a fuel cell, or a diesel engine generator. The distributed-power-supply-apparatus 370 can supply the generated power to the power system 310. The power demand of the energy community can be adjusted with the power supply from the distributed-power-supply-apparatus 370.

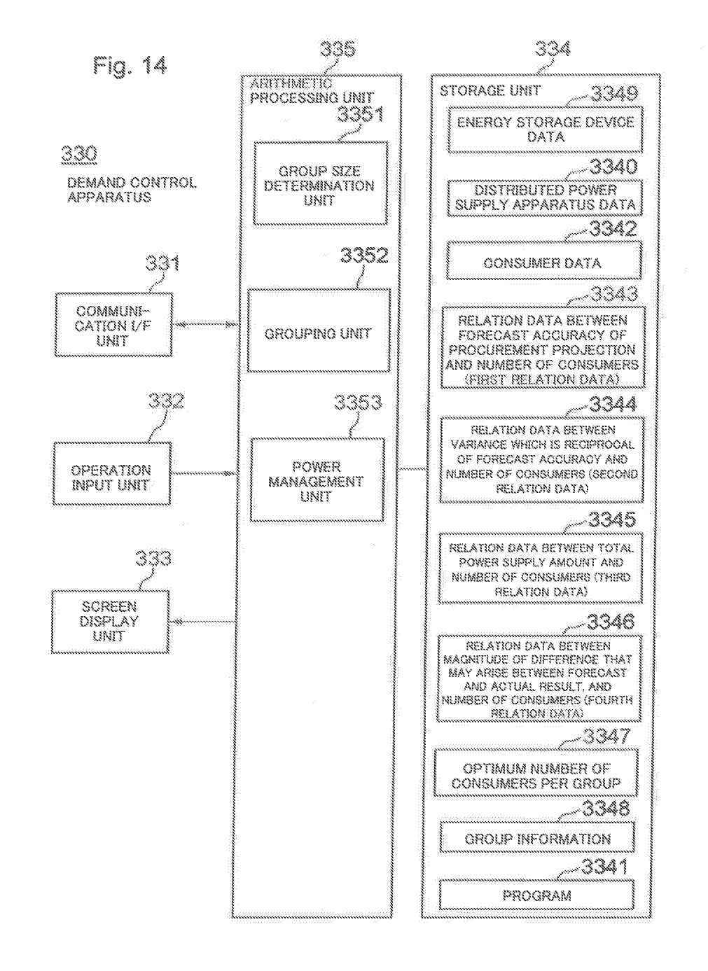

FIG. 14 is a block diagram of the demand control apparatus 330 according to this example embodiment. Referring to FIG. 14, the demand control apparatus 330 includes, as essential functional components, a communication interface unit (hereinafter, communication I/F unit) 331, an operation input unit 332, a screen display unit 333, a storage unit 334, and an arithmetic processing unit 335. Among the above, the communication I/F unit 331, the operation input unit 332, and the screen display unit 333 are configured to perform the same functions as the communication I/F unit 131, the operation input unit 132, and the screen display unit 133 of the demand control apparatus 130 according to the first example embodiment, respectively.

The storage unit 334 includes a storage device such as a hard disk or a memory, and serves to store therein processing information required for various processing performed by the arithmetic processing unit 335 and a program 3341. The program 3341 is utilized to realize the functional components by being read into the arithmetic processing unit 335 and executed. The program 3341 is read in advance from a non-illustrated external device or a storage medium by means of a data input/output function, for example the communication I/F unit 331, and stored in the storage unit 334. Essential processing information stored in the storage unit 334 includes consumer data 3342, relation data 3343 between the forecast accuracy of the procurement projection and the number of consumers, relation data 3344 between variance which is the reciprocal of the forecast accuracy and the number of consumers, relation data 3345 between total power supply amount and the number of consumers, relation data 3346 between magnitude of difference that may arise between forecast and actual result, and the number of consumers, the optimum number 3347 of consumers per group, group information 3348, energy storage apparatus data 3349, and distributed-power-supply-apparatus data 3340. Among the above, the consumer data 3342, the relation data 3343 between the forecast accuracy of the procurement projection and the number of consumers, the relation data 3344 between the variance which is the reciprocal of the forecast accuracy and the number of consumers, the relation data 3345 between the total power supply amount and the number of consumers, the relation data 3346 between the magnitude of difference that may arise between the forecast and the actual result, and the number of consumers, and the optimum number 3347 of consumers per group are the same as the consumer data 1342, the relation data 1343 between the forecast accuracy of the procurement projection and the number of consumers, the relation data 1344 between the variance which is the reciprocal of the forecast accuracy and the number of consumers, the relation data 1345 between the total power supply amount and the number of consumers, the relation data 1346 between the magnitude of difference that may arise between the forecast and the actual result, and the number of consumers, and the optimum number 1347 of consumers per group of the demand control apparatus 130 according to the first example embodiment, respectively.

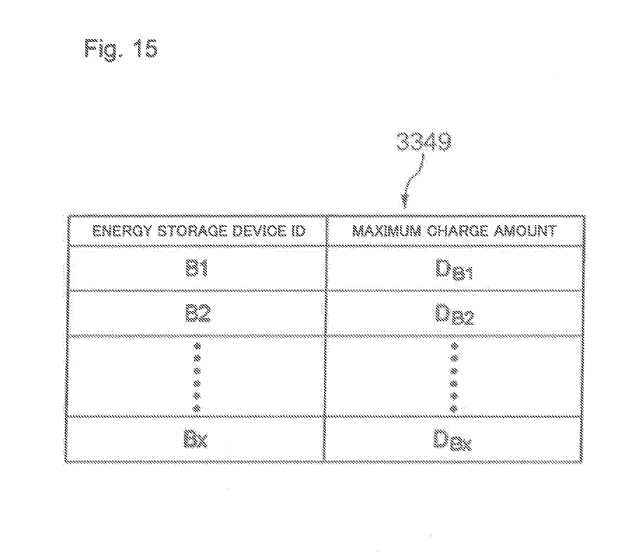

The energy storage apparatus data 3349 is related to each of the energy storage apparatuses 360. FIG. 15 represents an example of the energy storage apparatus data 3349. The energy storage apparatus data 3349 illustrated in FIG. 15 includes entries containing a set of an energy storage apparatus ID and maximum charge capacity, with respect to each of the energy storage apparatuses 360. For example, the entry of the uppermost column indicates that the maximum charge capacity of an energy storage apparatus having an ID of B1 is DB1.

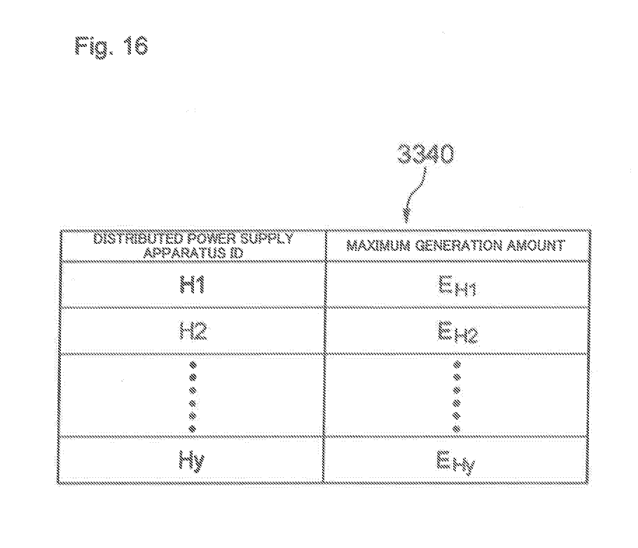

The distributed-power-supply-apparatus data 3340 is related to each of the distributed-power-supply-apparatuses 370. FIG. 16 represents an example of the distributed-power-supply-apparatus data 3340. The distributed-power-supply-apparatus data 3340 illustrated in FIG. 16 includes entries containing a set of a distributed-power-supply-apparatus ID and maximum generation capacity, with respect to each of the distributed-power-supply-apparatuses 370. For example, the entry of the uppermost column indicates that the maximum generation capacity of a distributed-power-supply-apparatus having an ID of H1 is EH1.

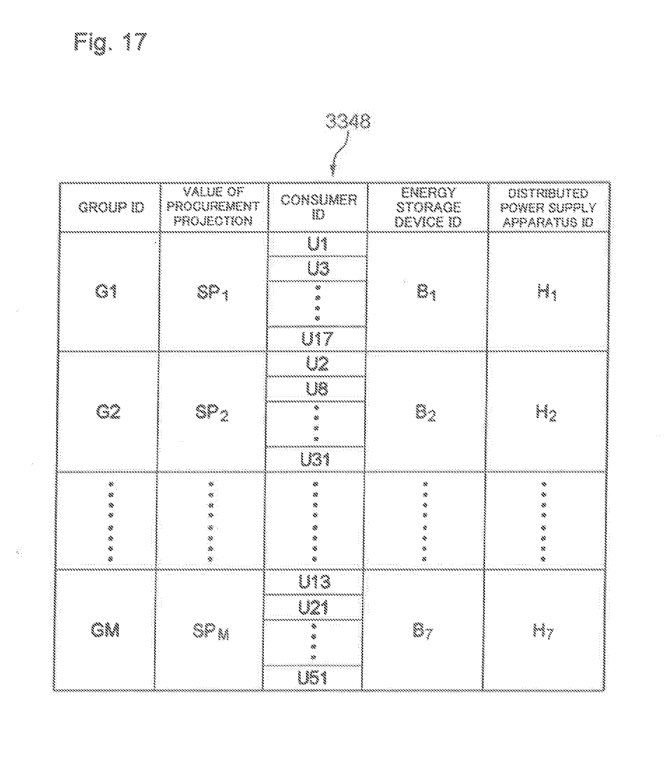

The group information 3348 is related to the plurality of consumer groups. FIG. 17 represents an example of the group information 3348. The group information 3348 illustrated in FIG. 17 includes entries containing a set of a group ID, the power procurement projection for the corresponding consumer group, and a list of consumers included in the consumer group (list of consumer IDs.), and IDs of the energy storage apparatus 360 and the distributed-power-supply-apparatus 370 assigned to the consumer group, with respect to each of the consumer groups. For example, the entry of the uppermost column indicates that the procurement projection for a consumer group having a consumer group ID of G1 is SP1, that the consumer group includes consumers respectively having a consumer ID of U1, U3, . . . , U17, and that the energy storage apparatus and the distributed-power-supply-apparatus respectively having the ID of B1 and H1 are assigned to the consumer group.

The arithmetic processing unit 335 includes a microprocessor such as an MPU and peripheral circuits, and is configured to read the program 3341 from the storage unit 334 and execute the same, to thereby cause the hardware and the program 3341 to collaborate in such a way to realize various functional units. Examples of the functional units realized by the arithmetic processing unit 335 include a group size determination unit 3351, a grouping unit 3352, and a power management unit 3353. Among the above, the group size determination unit 3351 is configured to perform the same function as the group size determination unit 1351 in the demand control apparatus 130 according to the first example embodiment.

The grouping unit 3352 is configured to read the consumer data 3342 and the optimum number 334 of consumers per group from the storage unit 334, divide all the consumers 320 listed up in the consumer data 3342 into a plurality of groups including the same number of consumers 320 as the optimum number 3347, generate the group information 3348 through the dividing of the consumers, and store the group information 3348 in the storage unit 334. The procurement projection for each group in the group information 3348 may be made up by a desired method, for example making a forecast based on past demand measurement data of the consumers 320 included in the same group. Alternatively, the grouping unit 3352 may adopt any of the first to the sixth group dividing methods described with reference to the first example embodiment. It is to be noted, however, that the disclosed subject matter is not limited to those methods.

The grouping unit 3352 also reads the energy storage apparatus data 3349 and the distributed-power-supply-apparatus data 3340 from the storage unit 334, and assigns the energy storage apparatus 360 and the distributed-power-supply-apparatus 370 to each of the consumer groups registered In the group information 3348. The grouping unit 3352 then registers the respective IDs of the energy storage apparatus 360 and the distributed-power-supply-apparatus 370 assigned, in the group information 3348. The assignment may be performed by any of the following methods. It is to be noted, however, that the disclosed subject matter is not limited to those methods.

### <First Example of Assignment Method>

One or more energy storage apparatuses 360 that are different from each other may be assigned to each of the consumer groups.

### <Second Example of Assignment Method>

One or more energy storage apparatuses 360 that are different from each other may be assigned to each of the consumer groups, in such a way to satisfy the condition that the total of the maximum charge capacity of the energy storage apparatuses 360 in the group is equal to or larger than a reference value. In this case, the grouping unit 3352 may read the fourth relation data 3346 from the storage unit 334, analyze the fourth relation data 3346 to thereby obtain the minimum value of the difference between the total sum of the demand power of the consumers 320 in the same group and the forecasted value of the total sum, and adopt the minimum value as the reference value. Although the grouping unit 3352 obtains the minimum value of the difference in this example, the group size determination unit 3351 may obtain the minimum value and store it in the storage unit 334.

### <Third Example of Assignment Method>

One or more distributed-power-supply-apparatuses 370 that are different from each other may be assigned to each of the consumer groups.

### <Fourth Example of Assignment Method>

One or more distributed-power-supply-apparatuses 370 that are different from each other may be assigned to each of the consumer groups, in such a way to satisfy the condition that the total of the maximum generation capacity of the distributed-power-supply-apparatuses 370 in the group is equal to or larger than a reference value. In this case, the grouping unit 3352 may read the fourth relation data 3346 from the storage unit 334, analyze the fourth relation data 3346 to thereby obtain the minimum value of the difference between the total sum of the demand power of the consumers 320 in the same group and the forecasted value of the total sum, and adopt the minimum value as the reference value. Although the grouping unit 3352 obtains the minimum value of the difference in this example, the group size determination unit 3351 may obtain the minimum value and store it in the storage unit 334.

The power management unit 3353 is configured to read the group information 3348 from the storage unit 334, and adjust the demand power of the consumer group in such a way to bring the demand power close to the procurement projection of the consumer group, with respect to each of the consumer groups registered in the group information 3348. For example, the power management unit 3353 makes communication with the energy management apparatus (125) of the consumer 320 through the communication network 340 by means of the communication I/F unit 331, to thereby acquire the power demand amount measured by the sensor (121) of each consumer 320, and calculates the power demand amount of each consumer group by aggregating the respective power demand amounts of the consumers 320 in the same group. Then the power management unit 3353 compares between the procurement projection of the group registered in the group information 3348 and the power demand of the group measured as above, with respect to each of the consumer groups. In a case where the actual power demand of any of the consumer groups has exceeded, or is likely to exceed, the procurement projection, the power management unit 3353 reduces the demand power of the corresponding consumer group. In contrast, in the case where the actual power demand of any of the consumer groups has not reached, or is likely to fail to reach, the procurement projection, and the power management unit 3353 increases the demand power of the corresponding consumer group. Here, the power management unit 3353 may adopt any of the following reducing methods or increasing methods of the demand power. It is to be noted, however, that the disclosed subject matter is not limited to the methods described hereunder.

### <First Example of Demand Power Reducing Method>

The power management unit 3353 may cause the energy storage apparatus 360 assigned to the consumer group to discharge. The power management unit 3353 identifies the energy storage apparatus 360 assigned to the consumer group by looking up the energy storage apparatus ID in the group information 3348. The power management unit 3353 also checks whether the energy storage apparatus 360 is not discharging and has a sufficient remaining charge, by making an inquiry to the energy storage apparatus 360 through the communication network 340 by means of the communication I/F unit 331. Then the power management unit 3353 transmits an instruction to start to discharge to the energy storage apparatus 360 through the communication network 340 by means of the communication I/F unit 331. Accordingly, the charged power in the energy storage apparatus 360 is supplied to the power system 310. As result, the demand power of the relevant consumer is reduced. When a plurality of energy storage apparatuses 360 are assigned to the consumer group, all or a part of the energy storage apparatuses 360 that are prepared to discharge may be caused to discharge.

### <Second Example of Demand Power Reducing Method>

The power management unit 3353 may cause the distributed-power-supply-apparatus 370 assigned to the consumer group to generate power. The power management unit 3353 identifies the distributed-power-supply-apparatus 370 assigned to the consumer group by looking up the distributed-power-supply-apparatus ID in the group information 3348. The power management unit 3353 also checks whether the distributed-power-supply-apparatus 370 is generating power, by making an inquiry to the distributed-power-supply-apparatus 370 through the communication network 340 by means of the communication I/F unit 331. Then the power management unit 3353 transmits an instruction to start to generate power to the distributed-power-supply-apparatus 370 through the communication network 340 by means of the communication I/F unit 331. Accordingly, the distributed-power-supply-apparatus 370 starts to generate power and the power thus generated is supplied to the power system 310. As result, the demand power of the relevant consumer 320 is reduced. When a plurality of distributed-power-supply-apparatuses 370 are assigned to the consumer group, all or a part of the distributed-power-supply-apparatuses 370 that are prepared to generate power may be caused to generate power.

### <First Example of Demand Power Increasing Method>

The power management unit 3353 may cause the energy storage apparatus 360 assigned to the consumer group to be charged. The power management unit 3353 identifies the energy storage apparatus 360 assigned to the consumer group by looking up the energy storage apparatus ID in the group information 3348. The power management unit 3353 also checks whether the energy storage apparatus 360 is not being charged and not fully charged, by making an inquiry to the energy storage apparatus 360 through the communication network 340 by means of the communication I/F unit 331. Then the power management unit 3353 transmits an instruction to start to charge to the energy storage apparatus 360 through the communication network 340 by means of the communication I/F unit 331. Accordingly, the energy storage apparatus 360 is charged with the power from the power system 310. As result, the demand power of the relevant consumer group is increased. When a plurality of energy storage apparatuses 360 are assigned to the consumer group, the charging may be performed to all or a part of the energy storage apparatuses 360 that can be charged.

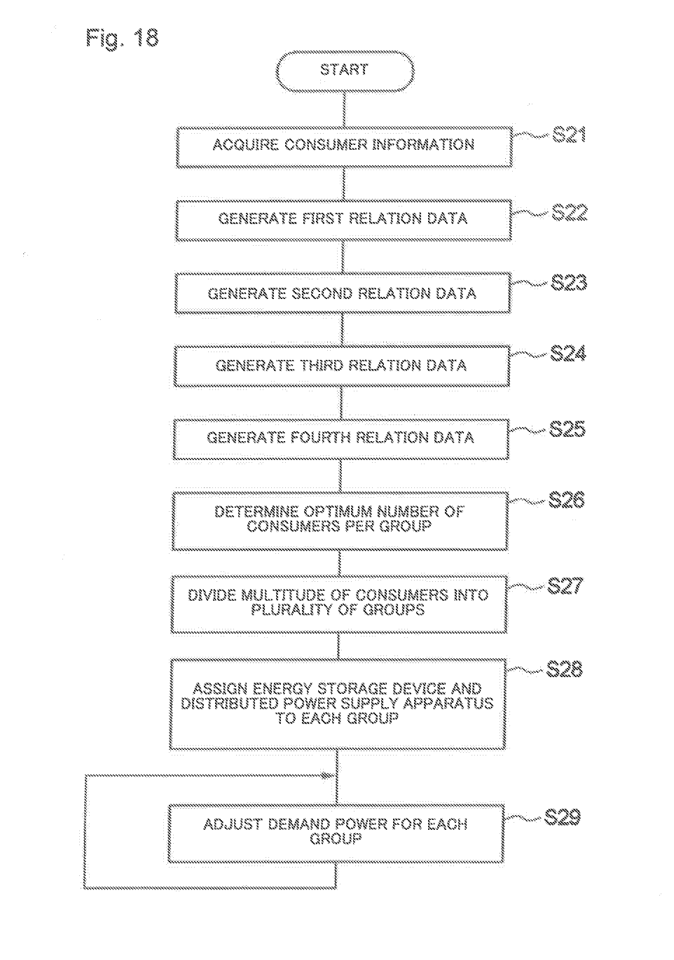

FIG. 18 is a flowchart illustrating an operation of the demand control apparatus 330. Referring to FIG. 18, the operation of the power demand control system 300 according to this example embodiment will be described hereunder.

The group size determination unit 3351 of the demand control apparatus 330 executes the process same as steps S1 to S6 illustrated in FIG. 10, executed by the group size determination unit 1351 according to the first example embodiment (step S21 to S26). Thus, the optimum number 3347 of consumers per group is determined. Then the grouping unit 3352 of the demand control apparatus 330 executes the process same as step S7 illustrated in FIG. 10, executed by the grouping unit 1352 according to the first example embodiment (step S27). As result, all the consumers 320 listed up in the consumer data 3342 are divided into a plurality of groups including the same number of consumers 320 as the optimum number 3347, and the group information 3348 of the consumer group obtained through the mentioned division is stored in the storage unit 334.

The grouping unit 3352 assigns the energy storage apparatus 360 registered in the energy storage apparatus data 3349 and the distributed-power-supply-apparatus 370 registered in the distributed-power-supply-apparatus data 3340 to each of the consumer groups registered in the group information 3348, and registers the respective IDs of the energy storage apparatus 360 and the distributed-power-supply-apparatus 370 in the group information 3348 (step S28).

Then the power management unit 3353 adjusts, with respect to each of the consumer groups registered in the group information 3348, the demand power of the consumer group in such a way to bring the demand power close to the procurement projection of the corresponding consumer group (step S29).

As described above, the arrangement according to this example embodiment facilitates the demand power of the consumer group to be brought close to the procurement projection of the same consumer group. This is because the plurality of consumers are divided into the groups such that the difference between the total sum of the demand power of the consumers included in the same group and the forecasted value of the total sum becomes minimum.

The arrangement according to this example embodiment also facilitates the demand power of the consumer group to be brought close to the procurement projection of the same consumer group, through the charging or discharging of the energy storage apparatus provided independently from the consumer. This is because one or more energy storage apparatuses 360 that are different from each other are selected out of the energy storage apparatuses 360 provided independently from the consumers and assigned to each of the consumer groups, in such a way to satisfy the condition that the total of the maximum charge capacity of the energy storage apparatuses in the group is equal to or larger than the reference value.

The arrangement according to this example embodiment also facilitates the demand power of the consumer group to be brought close to the procurement projection of the same consumer group, through the power generation by the distributed-power-supply-apparatus provided independently from the consumer. This is because one or more distributed-power-supply-apparatuses that are different from each other are selected out of the distributed-power-supply-apparatuses 370 provided independently from the consumers and assigned to each of the consumer groups, in such a way to satisfy the condition that the total of the maximum generation capacity of the distributed-power-supply-apparatuses in the group is equal to or larger than the reference value.

### Fourth Example Embodiment

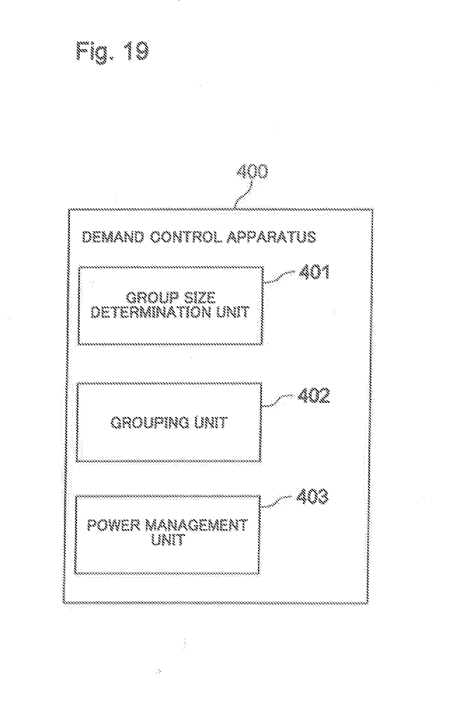

Referring to FIG. 19, a demand control apparatus 400 according to a fourth example embodiment is coupled via a communication network to a plurality of consumers coupled to a non-illustrated power system, and includes a group size determination unit 401, a grouping unit 402, and a power management unit 403.

The group size determination unit 401 is configured to determine the number of consumers per group that makes the difference minimum or not larger than a threshold, between the total sum of the demand power of the consumers in the same group and the forecasted value of the total sum. The grouping unit 402 is configured to divide the plurality of consumers into a plurality of consumer groups in accordance with the number of consumers determined by the group size determination unit 401. The power management unit 403 is configured to adjust, with respect to each of the consumer groups, the demand power of the consumer group in such a way to bring the demand power close to the procurement projection of the consumer group.

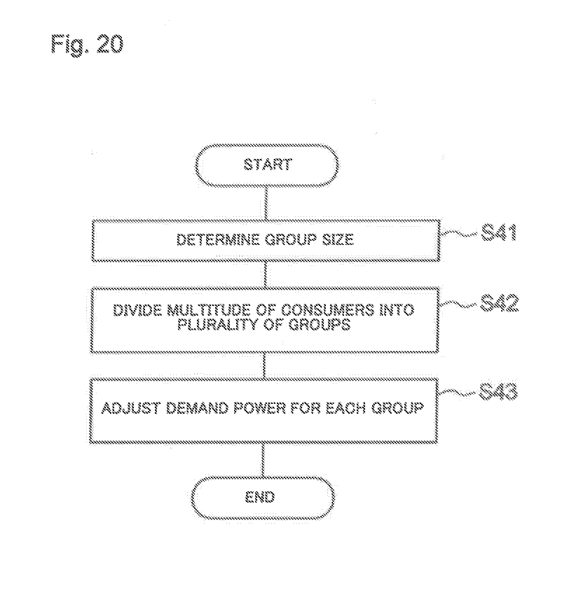

FIG. 20 is a flowchart illustrating the operation of the demand control apparatus 400 according to this example embodiment. Referring to FIG. 20, first the group size determination unit 401 determines the number of consumers per group that makes the difference minimum or not larger than the threshold, between the total sum of the demand power of the consumers in the same group and the forecasted value of the total sum (step S41). Then the grouping unit 402 divides the plurality of consumers into a plurality of consumer groups in accordance with the number of consumers determined by the group size determination unit 401 (step S42). The power management unit 403 then adjusts the demand power of the consumer group in such a way to bring the demand power close to the procurement projection of the consumer group, with respect to each of the consumer groups (step S43).

The arrangement according to this example embodiment facilitates the demand power of the consumer group to be brought close to the procurement projection of the same consumer group. This is because the plurality of consumers are divided into the groups such that the difference between the total sum of the demand power of the consumers included in the same group and the forecasted value of the total mm becomes minimum or not larger than the threshold.

### Fifth Example Embodiment

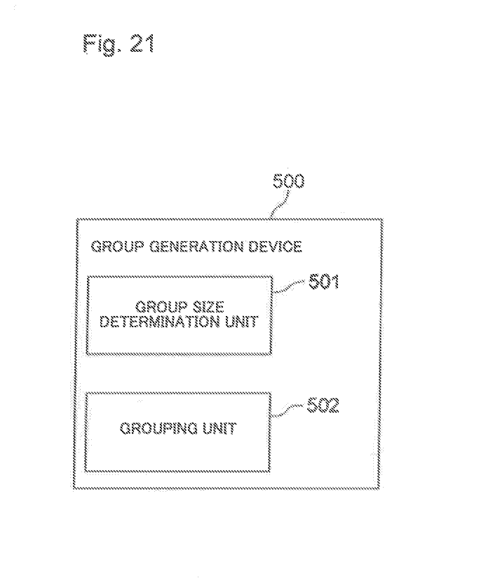

Referring to FIG. 21, a group generation apparatus 500 according to a fifth example embodiment is coupled via a communication network to a plurality of consumers coupled to a non-illustrated power system, and includes a group size determination unit 501 and a grouping unit 502.

The group size determination unit 501 is configured to determine the number of consumers per group that makes the difference minimum or not larger than a threshold, between the total sum of the demand power of the consumers in the same group and the forecasted value of the total sum. The grouping unit 502 is configured to divide the plurality of consumers into a plurality of consumer groups in accordance with the number of consumers determined by the group size determination unit 501.

FIG. 21 is a flowchart illustrating the operation of the group generation apparatus 500 according to this example embodiment. Referring to FIG. 21, first the group size determination unit 501 determines the number of consumers per group that makes the difference minimum or not larger than the threshold, between the total sum of the demand power of the consumers in the same group and the forecasted value of the total sum (step S51). Then the grouping unit 502 divides the plurality of consumers into a plurality of consumer groups in accordance with the number of consumers determined by the group size determination unit 501 (step S52).

The arrangement according to this example embodiment facilitates the demand power of the consumer group to be brought close to the procurement projection of the same consumer group. This is because the plurality of consumers are divided into the groups such that the difference between the total sum of the demand power of the consumers included in the same group and the forecasted value of the total sum becomes minimum or not larger than the threshold.

### Other Example Embodiments

Although the disclosed subject matter has been described above with reference to some example embodiments, the disclosed subject matter is in no way limited to the foregoing example embodiments, but various additions or modifications may be made. For example, the following example embodiments are also within the scope of the disclosed subject matter.

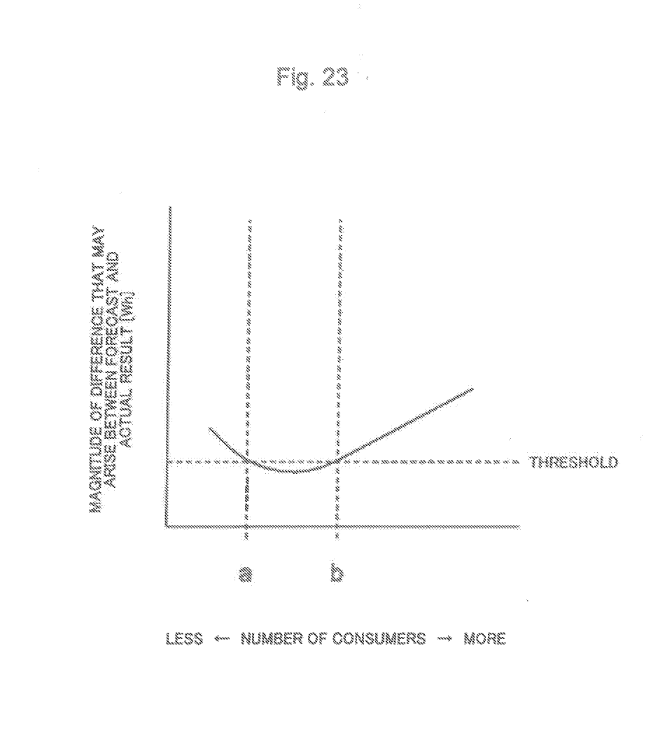

According to the foregoing example embodiments, the group size determination unit is configured to determine the number of consumers per group that makes the difference minimum, between the total sum of the demand power of the consumers in the same group and the forecasted value of the total sum. However, the number of consumers per group that makes the difference equal to or larger than a predetermined threshold may be determined, instead of determining the number of consumers per group that makes the difference minimum. For example, in the example illustrated in FIG. 23, in which an example of the threshold is added to the fourth relation data illustrated in FIG. 8, the numbers between the number of consumers a and the number of consumers b are determined as the number of consumers per group. Therefore, the grouping unit divides the plurality of consumers into a plurality of consumer groups such that the number of consumers of each group falls within the range between the number of consumers a and the number of consumers b.

This application claims priority based on Japanese Patent Application No. 2014-240001 filed on Nov. 27, 2014, the entire content of which Is incorporated hereinto by reference.

### INDUSTRIAL APPLICABILITY

The disclosed subject matter can be utilized to control power for an energy community that includes a plurality of consumers coupled to a power system, in particular to bring demand power close to a procurement projection set up in advance. The disclosed subject matter is also applicable to such purposes as power transaction, power retailing, and power interchange.

A part or the whole of the foregoing example embodiments may be expressed as, but are not limited to, the following Supplementary Notes.

### [Supplementary Note 1]

A power demand control system includes;

a plurality of consumers coupled to a power system and a demand control apparatus coupled to the plurality of consumers via a communication network,

wherein the plurality of consumers are divided into a plurality of consumer groups, such that a difference between a total sum of demand power of the consumers included in a same group and a forecasted value of the total sum becomes minimum or equal to or smaller than a threshold, and

the demand control apparatus adjusts, with respect to each of the consumer groups, demand power of the consumer group in such a way to bring the demand power of consumer group close to a procurement projection of the consumer group.

### [Supplementary Note 2]

A demand control apparatus coupled via a communication network to a plurality of consumers coupled to a power system, the demand control apparatus comprising:

a group size determination unit that determines a number of consumers per group that makes a difference minimum or equal to or smaller than a threshold, between a total sum of demand power of the consumers included in a same group and a forecasted value of the total sum;

a grouping unit that divides the plurality of consumers into a plurality of consumer groups in accordance with the number of consumers determined; and

a power management unit that adjusts, with respect to each of the consumer groups, the demand power of the consumer group in such a way to bring the demand power of the consumer group close to the procurement projection of the consumer group.

### [Supplementary Note 3]

The demand control apparatus according to claim 2,

wherein the group size determination unit that determines a number of consumers per group that makes a difference minimum or equal to or smaller than a threshold, between a total sum of demand power of the consumers included in a same group and a forecasted value of the total sum.

### [Supplementary Note 4]

The demand control apparatus according to Supplementary Note 2 or 3,

in which the group size determination unit is configured to:

calculate first relation data representing a relationship between forecast accuracy of the procurement projection and the number of consumers based on a past operation result;

calculate second relation data representing a relationship between variance which is a reciprocal of the forecast accuracy and the number of consumers;

calculate third relation data representing a relationship between a total power supply amount and the number of consumers based on the past operation result;

calculate, based on the second relation data and the third relation data, fourth relation data representing a relationship between magnitude of difference between a total sum of demand power of the consumers included in a same group and a forecasted value of the total sum, and the number of consumers per group: and

calculate the number of consumers per group based on the fourth relation data.

### [Supplementary Note 5]

The demand control apparatus according to any one of Supplementary Notes 2 to 4.

in which the group size determination unit determines a minimum value of the difference.

### [Supplementary Note 6]

The demand control apparatus according to Supplementary Note 5,

in which the grouping unit divides the plurality of consumers into a plurality of consumer groups, in such a way to satisfy a condition that each group includes at least one consumer having an energy storage apparatus, and a total of maximum charge capacity of the energy storage apparatuses in the same group is equal to or larger than the minimum value of the difference.

### [Supplementary Note 7]

The demand control apparatus according to Supplementary Note 5 or 6,

in which the grouping unit divides the plurality of consumers into a plurality of consumer groups, in such a way to satisfy a condition that each group includes at least one consumer having a distributed-power-supply-apparatus, and a total of maximum generation capacity of the distributed-power-supply-apparatuses in the same group is equal to or larger than the minimum value of the difference.

### [Supplementary Note 8]

The demand control apparatus according to any one of Supplementary Notes 5 to 7,

in which the grouping unit assigns an energy storage apparatus provided independently from the consumer and having a maximum charge capacity equal to or larger than the minimum value of the difference, to each of the consumer groups,

### [Supplementary Note 9]

The demand control apparatus according to any one of Supplementary Notes 5 to 8,

in which the grouping unit assigns a distributed-power-supply-apparatus provided independently from the consumer and having a maximum generation capacity equal to or larger than the minimum value of the difference, to each of the consumer groups,

### [Supplementary Note 10]

A group generation apparatus coupled via a communication network to a plurality of consumers coupled to a power system, the group generation apparatus includes:

a group size determination unit that determines a number of consumers per group that makes a difference minimum or equal to or smaller than a threshold, between a total sum of demand power of the consumers included in a same group and a forecasted value of the total sum; and

a grouping unit that divides the plurality of consumers into a plurality of consumer groups in accordance with the number of consumers determined.

### [Supplementary Note 11]

The group generation apparatus according to Supplementary Note 10,

in which the group size determination unit obtains a relationship between magnitude of difference between the total sum of demand power of the consumers included in the same group and the forecasted value of the total sum, and the number of consumers per group, based on accuracy of demand forecast and a forecasted value of the total power amount per group, and determines the number of consumers per group that makes the difference minimum or equal to or smaller than a threshold, based on the relationship obtained.

### [Supplementary Note 12]

The group generation apparatus according to Supplementary Note 10 or 11,

in which the group size determination unit is configured to:

calculate first relation data representing a relationship between forecast accuracy of the procurement projection and the number of consumers based on a past operation result;

calculate second relation data representing a relationship between variance which is a reciprocal of the forecast accuracy and the number of consumers;

calculate third relation data representing a relationship between a total power supply amount and the number of consumers based on the past operation result;

calculate, based on the second relation data and the third relation data, fourth relation data representing a relationship between magnitude of difference between a total sum of demand power of the consumers included in a same group and a forecasted value of the total sum and the number of consumers per group; and

calculate the number of consumers per group based on the fourth relation data,

### [Supplementary Note 13]

The group generation apparatus according to any one of Supplementary Notes 10 to 12,

in which the group size determination unit determines a minimum value of the difference,

### [Supplementary Note 14]

The group generation apparatus according to Supplementary Note 13,

in which the grouping unit divides the plurality of consumers into a plurality of consumer groups, in such a way to satisfy a condition that each group includes at least one consumer having an energy storage apparatus, and a total of maximum charge capacity of the energy storage apparatuses in the same group is equal to or larger than the minimum value of the difference,

[Supplementary Note 15]

The group generation apparatus according to Supplementary Note 13 or 14,

in which the grouping unit divides the plurality of consumers into a plurality of consumer groups, in such a way to satisfy a condition that each group includes at least one consumer having a distributed-power-supply-apparatus, and a total of maximum generation capacity of the distributed-power-supply-apparatuses in the same group is equal to or larger than the minimum value of the difference,

### [Supplementary Note 16]

The group generation apparatus according to any one of Supplementary Notes 13 to 15.

in which the grouping unit assigns an energy storage apparatus provided independently from the consumer and having a maximum charge capacity equal to or larger than the minimum value of the difference, to each of the consumer groups.

### [Supplementary Note 17]

The group generation apparatus according to any one of Supplementary Notes 13 to 16,

in which the grouping unit assigns a distributed-power-supply-apparatus provided independently from the consumer and having a maximum generation capacity equal to or larger than the minimum value of the difference, to each of the consumer groups.

### [Supplementary Note 18]

A group generation method to be executed by a group generation apparatus coupled via a communication network to a plurality of consumers coupled to a power system, the group generation method includes:

determining a number of consumers per group that makes a difference minimum or equal to or smaller than a threshold, between a total sum of demand power of the consumers included in a same group and a forecasted value of the total sum; and

dividing the plurality of consumers into a plurality of consumer groups in accordance with the number of consumers determined,

### [Supplementary Note 19]

The group generation method according to Supplementary Note 18,

in which the determining of the number of consumers per group includes obtaining a relationship between magnitude of difference between the total sum of demand power of the consumers included in the same group and the forecasted value of the total sum, and the number of consumers per group, based on accuracy of demand forecast and a forecasted value of the total power amount per group, and determining the number of consumers per group that makes the difference minimum or equal to or smaller than a threshold, based on the relationship obtained.

### [Supplementary Note 20]

The group generation method according to Supplementary Note 18 or 19,

in which the determining of the number of consumers per group includes:

calculating first relation data representing a relationship between forecast accuracy of the procurement projection and the number of consumers based on a past operation result;

calculating second relation data representing a relationship between variance which is a reciprocal of the forecast accuracy and the number of consumers;

calculating third relation data representing a relationship between a total power supply amount and the number of consumers based on the past operation result;

calculating, based on the second relation data and the third relation data, fourth relation data representing a relationship between magnitude of difference between a total sum of demand power of the consumers included in a same group and a forecasted value of the total sum, and the number of consumers per group; and

calculating the number of consumers per group based on the fourth relation data,

### [Supplementary Note 21]

The group generation method according to any one of Supplementary Notes 18 to 20,

in which the determining of the number of consumers per group includes determining a minimum value of the difference.

### [Supplementary Note 22]

The group generation method according to Supplementary Note 21,

in which the dividing includes dividing the plurality of consumers into a plurality of consumer groups, in such a way to satisfy a condition that each group includes at least one consumer having an energy storage apparatus, and a total of maximum charge capacity of the energy storage apparatuses in the same group is equal to or larger than the minimum value of the difference.

### [Supplementary Note 23]

The group generation method according to Supplementary Note 21 or 22,

in which the dividing includes dividing the plurality of consumers into a plurality of consumer groups, in such a way to satisfy a condition that each group includes at least one consumer having a distributed-power-supply-apparatus, and a total of maximum generation capacity of the distributed-power-supply-apparatuses in the same group is equal to or larger than the minimum value of the difference,

### [Supplementary Note 24]

The group generation method according to any one of Supplementary Notes 21 to 23,

in which the dividing includes assigning an energy storage apparatus provided independently from the consumer and having a maximum charge capacity equal to or larger than the minimum value of the difference, to each of the consumer groups.

### [Supplementary Note 25]

The group generation method according to any one of Supplementary Notes 21 to 24,

in which the dividing includes assigning a distributed-power-supply-apparatus provided independently from the consumer and having a maximum generation capacity equal to or larger than the minimum value of the difference, to each of the consumer groups.

### [Supplementary Note 26]

A program configured to cause a computer, coupled via a communication network to a plurality of consumers coupled to a power system, to function as:

a group size determination unit that determines a number of consumers per group that makes a difference minimum or equal to or smaller than a threshold, between a total sum of demand power of the consumers included in a same group and a forecasted value of the total sum: and

a grouping unit that divides the plurality of consumers into a plurality of consumer groups in accordance with the number of consumers determined.

1-12. (canceled)

13. A group generation apparatus coupled via a communication network to a plurality of consumers coupled to a power system, the group generation apparatus comprising:
a group size determination unit that determines a number of consumers per group that makes a difference minimum or equal to or smaller than a threshold, between a total sum of demand power of the consumers included in a same group and a forecasted value of the total sum: and
a grouping unit that divides the plurality of consumers into a plurality of consumer groups in accordance with the number of consumers determined.

14. The group generation apparatus according to claim 13,
wherein the group size determination unit obtains a relationship between magnitude of difference between the total sum of demand power of the consumers included in the same group and the forecasted value of the total sum, and the number of consumers per group, based on accuracy of demand forecast and a forecasted value of the total power amount per group, and determines the number of consumers per group that makes the difference minimum or equal to or smaller than a threshold, based on the relationship obtained.

15. The group generation apparatus according to claim 13,
wherein the group size determination unit Is configured to:
calculate first relation data representing a relationship between forecast accuracy of a procurement projection and the number of consumers based on a past operation result;
calculate second relation data representing a relationship between variance which is a reciprocal of the forecast accuracy and the number of consumers:
calculate third relation data representing a relationship between a total power supply amount and the number of consumers based on the past operation result;
calculate, based on the second relation data and the third relation data, fourth relation data representing a relationship between magnitude of difference between a total sum of demand power of the consumers included in a same group and a forecasted value of the total sum, and the number of consumers per group; and
calculate the number of consumers per group based on the fourth relation data.

16. The group generation apparatus according to claim 13,
wherein the group size determination unit determines a minimum value of the difference,

17. The group generation apparatus according to claim 16,
wherein the grouping unit divides the plurality of consumers into a plurality of consumer groups, in such a way to satisfy a condition that each group includes at least one consumer having an energy storage apparatus, and a total of maximum charge capacity of the energy storage apparatuses In the same group is equal to or larger than the minimum value of the difference.

18. The group generation apparatus according to claim 18,
wherein the grouping unit divides the plurality of consumers into a plurality of consumer groups, in such a way to satisfy a condition that each group includes at least one consumer having a distributed-power-supply-apparatus, and a total of maximum generation capacity of the distributed-power-supply-apparatuses in the same group is equal to or larger than the minimum value of the difference.

19. The group generation apparatus according to claim 18,
wherein the grouping unit assigns an energy storage apparatus provided independently from the consumer and having a maximum charge capacity equal to or larger than the minimum value of the difference, to each of the consumer groups.

20. The group generation apparatus according to claim 18,
wherein the grouping unit assigns a distributed-power-supply-apparatus provided independently from the consumer and having a maximum generation capacity equal to or larger than the minimum value of the difference, to each of the consumer groups.

21. A demand control apparatus coupled via a communication network to a plurality of consumers coupled to a power system, the demand control apparatus comprising:
the group generation apparatus according to claim 13 and;
a power management unit that adjusts, with respect to each of a consumer groups, a demand power of the consumer group in such a way to bring the demand power of the consumer group close to a procurement projection of the consumer group.

22. A group generation method to be executed by a group generation apparatus coupled via a communication network to a plurality of consumers coupled to a power system, the group generation method comprising:
determining a number of consumers per group that makes a difference minimum or equal to or smaller than a threshold, between a total sum of demand power of the consumers included in a same group and a forecasted value of the total sum; and
dividing the plurality of consumers into a plurality of consumer groups in accordance with the number of consumers determined.

23. A non-transitory computer readable medium storing a program configured to cause a computer, coupled via a communication network to a plurality of consumers coupled to a power system, to function as:
a group size determination unit that determines a number of consumers per group that makes a difference minimum or equal to or smaller than a threshold, between a total sum of demand power of the consumers included in a same group and a forecasted value of the total sum; and
a grouping unit that divides the plurality of consumers into a plurality of consumer groups in accordance with the number of consumers determined.
